(19) United States
(12) Patent Application Publication
(10) Pub. No.: US 2019/0217869 A1
(43) Pub. Date: Jul. 18, 2019

(54) CONTROL APPARATUS, CONTROL METHOD, AND PROGRAM

(71) Applicant: PANASONIC INTELLECTUAL PROPERTY MANAGEMENT CO., LTD., Osaka (JP)

(72) Inventors: Akihito TAKEUCHI, Osaka (JP); Kaoru YOKOTA, Hyogo (JP); Hiroyuki WADA, Kyoto (JP); Toshihisa NAKANO, Osaka (JP); Takayuki FUJII, Osaka (JP); Yuusuke NEMOTO, Hyogo (JP)

(73) Assignee: PANASONIC INTELLECTUAL PROPERTY MANAGEMENT CO., LTD., Osaka (JP)

(21) Appl. No.: 16/244,453

(22) Filed: Jan. 10, 2019

(30) Foreign Application Priority Data
Jan. 12, 2018 (JP) 2018-003762
Feb. 21, 2018 (JP) 2018-028730
Oct. 19, 2018 (JP) 2018-197882

(51) Int. Cl. B60W 50/02; G07C 5/00; B60W 50/04

(52) U.S. Cl. CPC B60W 50/0205; G07C 5/008; B60W 2050/021; B60W 2050/046; B60W 50/045

(57) ABSTRACT

A control apparatus (communication device) includes: a determination unit which determines, based on a communication data item passing through a network to which a plurality of ECUs are connected in a system, an anomaly level of the communication data item or an operating state of the system; and a first control unit which (i) changes at least one of a method of transmitting a log of the communication data item and a method of storing the log of the communication data item, according to the anomaly level of the communication data item determined, or (ii) performs sampling on the communication data item according to a method of sampling corresponding to the operating state determined.

### CROSS REFERENCE TO RELATED APPLICATIONS

The present application is based on and claims priority of Japanese Patent Application No. 2018-003762 filed on Jan. 12, 2018, Japanese Patent Application No. 2018-028730 filed on Feb. 21, 2018, and Japanese Patent Application No. 2018-197882 filed on Oct. 19, 2018. The entire disclosures of the above-identified applications, including the specifications, drawings and claims are incorporated herein by reference in their entirety.

### FIELD

The present disclosure relates to a control apparatus, a control method, and a program, for use in communication with an external device.

### BACKGROUND

A remote diagnosis system has been developed conventionally, for analyzing a failure of a vehicle by an external server, by transmitting information obtained from an electronic control unit (ECU) connected to an in-vehicle network, to the external server via a communication module in a vehicle. In addition, in recent years, it has been increasingly importance to accumulate vehicle information in a vehicle and transmit the vehicle information to an external server, as in the case of, to counter an attack (hacking) against an in-vehicle network of a vehicle, transmitting information obtained from an ECU to the external server, collecting the information, and analyzing the information to detect an attack such as transmission of an unauthorized message from an attacker. However, for carrying out such analysis, etc., a significantly large communication band is required to transmit, from a vehicle to a server device, etc, information related to all the messages passing through a bus in the in-vehicle network.

Patent Literature (PTL) 1 describes a communication method of varying an amount of data transmitted, according to a data output pattern transmitted by a server device, such that the total sum of the amount of data transmitted from a part of a plurality of electronic control units does not exceed a predetermined value. With this, it is possible to reduce the load of communication between the vehicle and the server device and a storage capacity of the server device.

PTL 2 discloses a vehicle safety system which includes a cyber watchman provided in each of a plurality of vehicles and a cyber hub provided outside the vehicle. The cyber watchman is connected to an in-vehicle communication network, and obtains communication traffic data on the in-vehicle communication network. The cyber hub receives the communication traffic data obtained by the cyber watchman, from the cyber watchman through a communication network such as the Internet. This enables the cyber hub to collect the communication traffic data from the plurality of vehicles, and to obtain high-order information to counter against cyber attacks against the vehicle.

### CITATION LIST

### Patent Literature

[PTL 1] Japanese Unexamined Patent Application Publication No. 2007-173934

[PTL 2] Japanese Unexamined Patent Application Publication No. 2015-136107

### SUMMARY

### Technical Problem

However, with the communication method described in PTL 1, the data output pattern is transmitted by the server irrespective of a state of a vehicle. Accordingly, there is a possibility of transmitting, by a large amount, vehicle data whose value barely changes according to a state of the vehicle, to a device external to the vehicle such as a server device. One example of such a case is to increase the amount of vehicle data which indicates a vehicle speed that is approximately zero because the vehicle is stopped.

In addition, with the technique disclosed by PTL 2, the cyber hub needs to receive data from the cyber watchmen of the plurality of vehicles, and thus there are instances where the amount of communication data becomes enormous. Furthermore, the cyber watchman of each of the vehicles needs to constantly obtain communication traffic data for monitoring the in-vehicle communication network, and thus there are instances where a storage device with an enormous capacity for storing data is required.

Accordingly, there is a problem that it is difficult to effectively reduce the load of communication with a device external to the vehicle and the storage capacity of the device.

An object of the present disclosure is to provide a control apparatus, etc. capable of effectively reducing the load of communication with an external device and a storage capacity of the device.

### Solution to Problem

In order to achieve the above-described object, a control apparatus according to an aspect of the present disclosure includes: a first determination unit configured to determine, based on a communication data item passing through a network to which a plurality of electronic control units are connected in a system, an anomaly level of the communication data item or an operating state of the system; and a first control unit configured to (i) change at least one of a method of transmitting a log of the communication data item and a method of storing the log of the communication data item, according to the anomaly level of the communication data item determined, or (ii) perform sampling on the communication data item according to a method of sampling corresponding to the operating state determined.

In addition, in order to achieve the above-described object, a control method according to an aspect of the present disclosure includes: determining, based on a communication data item passing through a network to which a plurality of electronic control units are connected in a system, an anomaly level of the communication data item or an operating state of the system; and (i) changing at least one of a method of transmitting a log of the communication data item and a method of storing the log of the communication data item, according to the anomaly level of the communication data item determined, or (ii) performing sampling on the communication data item according to a method of sampling corresponding to the operating state determined.

In addition, in order to achieve the above-described object, a recording medium according to an aspect of present disclosure is a non-transitory computer-readable recording medium for use in a computer, the recording medium having a computer program recorded thereon for causing the computer to execute: determining, based on a communication data item passing through a network to which a plurality of electronic control units are connected in a system, an anomaly level of the communication data item or an operating state of the system; and (i) changing at least one of a method of transmitting a log of the communication data item and a method of storing the log of the communication data item, according to the anomaly level of the communication data item determined, or (ii) performing sampling on the communication data item according to a method of sampling corresponding to the operating state determined.

### Advantageous Effects

According to the present disclosure, it is possible to effectively reduce the load of communication with an external device and a storage capacity of the device.

### BRIEF DESCRIPTION OF DRAWINGS

These and other objects, advantages and features of the present disclosure will become apparent from the following description thereof taken in conjunction with the accompanying drawings that illustrate a specific embodiment of the present disclosure.

FIG. 1 is a diagram which illustrates a configuration of a communication system according to Embodiment 1.

FIG. 2 is a diagram which illustrates a format of a data frame defined by a CAN protocol.

FIG. 3 is a diagram which illustrates a configuration of a communication device according to Embodiment 1.

FIG. 4 is a diagram which illustrates one example of a transfer list according to Embodiment 1.

FIG. 5A is a diagram which illustrates one example of a driving state pattern corresponding to a normal driving state according to Embodiment 1.

FIG. 5B is a diagram which illustrates another example of the driving state pattern corresponding to the normal driving state according to Embodiment 1.

FIG. 6 is a diagram which illustrates one example of the driving state pattern corresponding to an anomalous driving state according to Embodiment 1.

FIG. 7 is a diagram which illustrates another example of a group according to Embodiment 1.

FIG. 8 is a diagram which illustrates another example of the driving state pattern corresponding to the normal driving state according to Embodiment 1.

FIG. 9 is a flowchart which illustrates one example of a procedure of determining a sampling method according to Embodiment 1.

FIG. 10 is a flowchart which illustrates another example of the procedure of determining the sampling method according to Embodiment 1.

FIG. 11 is a flowchart which illustrates one example of an operation of the communication device according to Embodiment 1.

FIG. 12 is a diagram which illustrates a configuration of a communication system according to another aspect of Embodiment 1.

FIG. 13 is a block diagram which illustrates a functional configuration of a monitoring system according to Embodiment 2.

FIG. 14 is a diagram which illustrates one example of a full log according to Embodiment 2.

FIG. 15 is a sequence diagram of the monitoring system according to Embodiment 2.

FIG. 16 is a flowchart which illustrates a first operation of the monitoring device according to Embodiment 2.

FIG. 17 is a diagram which indicates a location of an acceleration amount in a CAN message according to Embodiment 2.

FIG. 18 is a diagram which illustrates one example of a first feature value according to Embodiment 2.

FIG. 19 is a diagram which illustrates one example of a second feature value according to Embodiment 2.

FIG. 20 is a diagram which illustrates one example of a third feature value according to Embodiment 2.

FIG. 21 is a diagram which illustrates one example of a combination of a plurality of feature values according to Embodiment 2.

FIG. 22A is a conceptual diagram which illustrates one example of anomaly level determination using one feature value according to Embodiment 2.

FIG. 22B is a conceptual diagram which illustrates another example of the anomaly level determination using one feature value according to Embodiment 2.

FIG. 23A is a conceptual diagram which illustrates one example of anomaly level determination using two feature values according to Embodiment 2.

FIG. 23B is a conceptual diagram which illustrates another example of the anomaly level determination using two feature values according to Embodiment 2.

FIG. 24 is a flowchart which illustrates a second operation of the monitoring device according to Embodiment 2.

FIG. 25 is a flowchart which illustrates an operation of a server according to Embodiment 2.

FIG. 26 is a conceptual diagram which illustrates one example of anomaly level determination using a learning model according to Embodiment 2.

FIG. 27 is a block diagram which illustrates a functional configuration of a monitoring system according to Embodiment 3.

FIG. 28 is a diagram which illustrates one example of monitoring data items according to Embodiment 3.

FIG. 29A is a diagram which illustrates one example of weighting data according to Embodiment 3.

FIG. 29B is a diagram which illustrates one example of weighting data according to Embodiment 3.

FIG. 30 is a flowchart which illustrates a first operation of the monitoring device according to Embodiment 3.

FIG. 31 is a flowchart which illustrates a second operation of the monitoring device according to Embodiment 3.

FIG. 32 is a diagram which illustrates one example of weighting data according to a variation example of Embodiment 3.

FIG. 33 is a diagram which illustrates one example of threshold data according to the variation example of Embodiment 3.

### DESCRIPTION OF EMBODIMENTS

Hereinafter, a control apparatus according to the present disclosure is referred to as a communication device in Embodiment 1 and a monitoring device in Embodiments 2 and 3.

### Embodiment 1

The following describes a communication system according to Embodiment 1 with reference to the drawings.

[1.1 Configuration of Communication System 10]

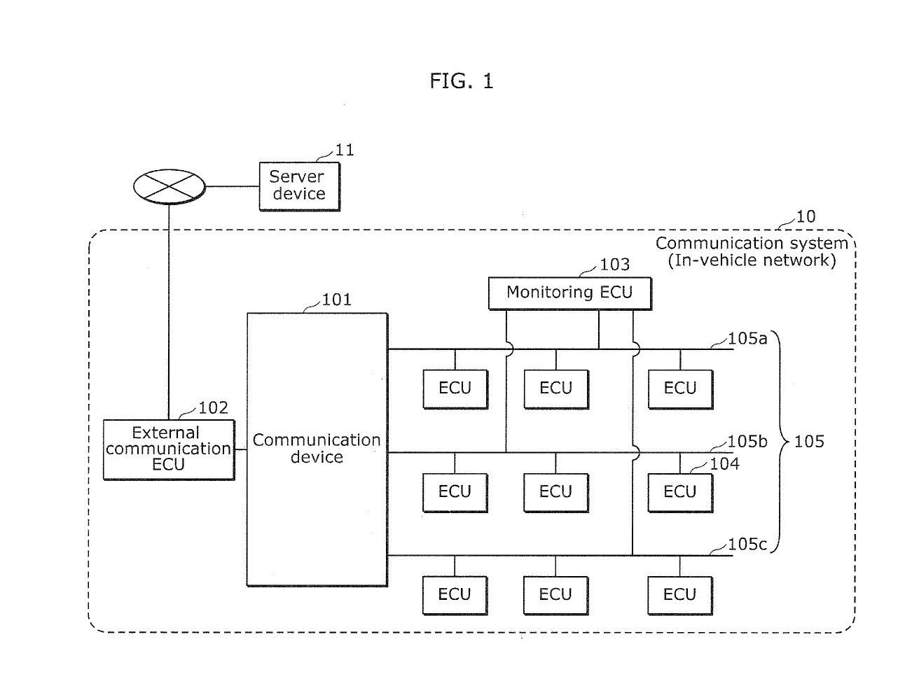

FIG. 1 is a diagram which illustrates a configuration of a communication system 10 according to Embodiment 1. It should be noted that FIG. 1 also illustrates a server device 11 connected to the communication system 10.

The communication system 10 is, for example, an in-vehicle network provided in a vehicle. It should be noted that, in the following description, the in-vehicle network is also referred to as a network. The communication system 10 is, for example, one example of an in-vehicle network which performs communication according to a controller area network (CAN) protocol, and is a network in a vehicle on which various devices such as a control apparatus, a sensor, an actuator, a user interface device, etc. are mounted. As illustrated in FIG. 1, the communication system 10 includes a communication device 101, an external communication ECU 102, a monitoring ECU 103, a plurality of ECUs 104, and CAN buses 105. Here, ECU stands for Electronic Control Unit. The communication device 101 is also one type of the ECU.

Examples of the plurality of ECUs 104 include a steering controller ECU, a steering ECU, an engine ECU, a brake ECU, a door opening and closing sensor ECU, a window opening and closing sensor ECU, etc., but not strictly limited.

The communication device 101 and each of the ECUs are devices including, for example, a processor (micro processor), a digital circuit such as a memory, an analogue circuit, a communication circuit, etc. The memory is a ROM, a RAM, etc., and capable of storing a control program (a computer program as a software) executed by a processor. For example, the processor operates according to a control program (computer program), thereby enabling the communication device 101 and each of the ECUs to implement various functions. The communication device 101 and each of the ECUs can exchange communication data via the CAN buses 105 in the vehicle, according to the CAN protocol.

The communication device 101 and each of the ECUs transmit and receive communication data according to the CAN protocol, to and from the CAN buses 105. For example, the communication device 101 and each of the ECUs receive communication data transmitted by the other ECU through the CAN buses 105. In addition, the communication device 101 and each of the ECUs generate communication data in which details desired to be transmitted to the other ECU is included, and transmits the generated communication data to the CAN buses 105. More specifically, the communication device 101 and each of the ECUs perform processing according to the details of the received communication data, and generate and transmit communication data including data indicating a state of a device, a sensor, etc. connected to the communication device 101 and each of the ECUs, or data such as an indication value (control value) to the other ECU. The generated communication data includes a CAN ID, and the communication device 101 and each of the ECUs are capable of receiving only communication data including a CAN ID predetermined to the communication device 101 and each of the ECUs, and thus it is possible to transmit communication data to an intended ECU.

In the communication system 10, the communication device 101, the external communication ECU 102, the monitoring ECU 103, and the plurality of ECUs 104, which are included in the in-vehicle network, are connected by the CAN buses 105. In the example illustrated in FIG. 1, a plurality of CAN buses 105a, 105b, and 105c are connected to one another via the communication device 101. It should be noted that the in-vehicle network need not be limited to a CAN. For example, the in-vehicle network may be a communication network based on Ethernet (registered trademark) or FlexRay (registered trademark).

In the in-vehicle network, each of the structural components such as the communication device 101, the external communication ECU 102, the monitoring ECU 103, and the plurality of ECUs 104 transmits and receives communication data (e.g., CAN command), thereby implementing various functions. For example, an advanced driver assistance system (ADAS) includes a parking assistance function, a lane keeping assistance function, and a collision avoidance assistance function. To implement these functions, actuators that each operate electronically-controlled steering, acceleration, or breaking are controlled by communication data that passes through the in-vehicle network.

The communication device 101 is connected to the CAN buses 105 to which the external communication ECU 102, the monitoring ECU 103, and the plurality of ECUs 104 are connected, receives communication data from the CAN buses 105, and transfers the received communication data to one of the CAN buses 105 specified by a CAN ID. The communication device 101 is also referred to as a gateway, in some cases. The communication device 101 has a function of performing sampling on communication data. Sampling means extracting communication data at a certain rate. How to extract communication data is not specifically limited. For example, when performing sampling on communication data passing through one of the CAN buses 105, data on a plurality of CAN IDs is passing in random order as communication data through the one of the CAN buses 105, and data is extracted at the same rate for each of the CAN IDs. This is for reducing disproportionately extracting only data on a particular CAN ID in communication data on which sampling is performed. It should be noted that an amount of communication data to be extracted is determined according to a sampling rate. For example, when the sampling rate is 100%, communication data is extracted at 100% (entirety of the data). In other words, the communication data is not reduced (i.e., not decimated). In addition, when the sampling rate is 50%, for example, communication data is extracted at 50% (half of the data). In other words, the communication data is reduced by half (i.e., decimated by half).

The external communication ECU 102 has a function of external communication to communicate with, for example, the server device 11 as a device external to the system (vehicle), via a wide area network such as the Internet. The external communication ECU 102 transmits communication data recorded by the communication device 101, to the server device 11 having an analyzing function.

The server device 11 communicates with the external communication ECU 102 included in the communication system 10 of various vehicles. The server device 11 is, for example, a computer or the like which receives, from vehicles of the same type, and collects information related to a message exchanged in each of the in-vehicle networks of the vehicles, and analyzes the collected information.

The monitoring ECU 103 is an ECU which monitors the in-vehicle network to see whether the in-vehicle network is in a normal state. The monitoring ECU 103 receives communication data from the plurality of CAN buses 105, determines whether the received communication data is normal, and notifies the communication device 101 of a result of the determination. The communication device 101 receives the result of determination, extracts communication data of a CAN bus 105 which is determined as not being normal among the plurality of CAN buses 105 at a sampling rate of 100%, and transmits the entirety or the communication data to the server device 11. The monitoring ECU 103, for example, holds a determination rule for determining an anomaly, and checks the communication data against the determination rule, thereby determining whether the communication data is anomalous. It should be noted that the communication device 101 may have a function of the monitoring ECU 103.

The plurality of ECUs 104 exchange messages via the CAN buses 105, according to the CAN protocol. For example, a message including data based on information obtained by a sensor is periodically transmitted from the ECUs 104 connected to the sensor, to the CAN buses 105. The messages are transmitted at an interval of hundreds of milliseconds, for example. In addition, the plurality of ECUs 104 include one ECU 104 which determines details of control to be performed on the actuator in a vehicle and performs control. For example, it is possible to estimate the driving state of the vehicle, based on the communication data exchanged by the one ECU 104.

For example, among the plurality of ECUs 104, ECUs 104 for attaining the same object may be connected to the same CAN bus 105 among the plurality of CAN buses 105. For example, ECUs 104 related to the ADAS are connected to the CAN bus 105a, ECUs 104 related to a powertrain are connected to the CAN bus 105b, and ECUs 104 related to a body of the vehicle (door, wiper, etc.) are connected to the CAN bus 105c.

In the communication system 10, each of the ECUs exchange frames such as a data frame as a message, according to the CAN protocols. Examples of the frame related to the CAN protocols include a data frame, a remote frame, an overload frame, and an error frame. The following description focuses on a data frame as a message including communication data.

[1.2 Data Frame Format]

Here, a data frame which is one of frames used in a network in accordance with a CAN protocol.

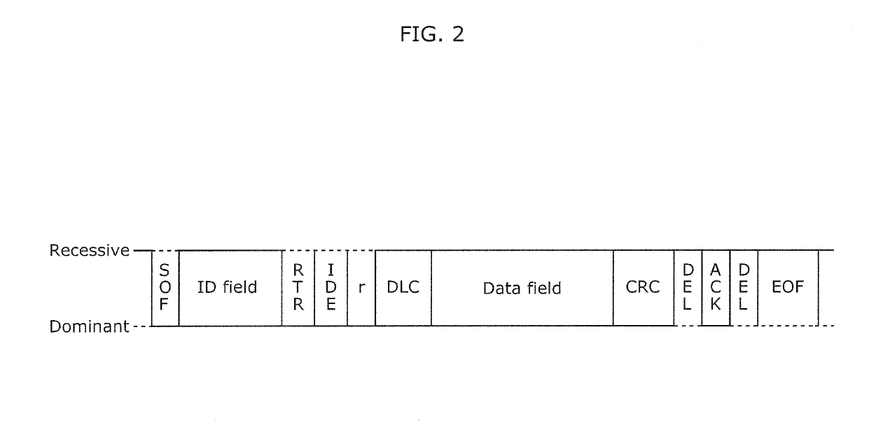

FIG. 2 is a diagram which illustrates a format of a data frame defined by the CAN protocol. In the diagram, a data frame in a standard ID format defined by a CAN protocol is illustrated. The data frame includes the following fields: a start of frame (SOF); an ID field; a remote transmission request (RTR); an identifier extension (IDE); a reserved bit “r”; a data length code (DLC); a data field, a cyclic redundancy check (CRC) sequence; a CRC delimiter “DEL”; an acknowledgement (ACK) slot; an ACK delimiter “DEL”; and an end of frame (EOF). The following omits description of the SOF, the RTR, the IDE, the reserved bit “r”, the DLC, the CRC sequence, the CRC delimiter “DEL”, the ACK slot, the ACK delimiter “DEL”, and the EOF.

The ID field is made up of 11 bits and stores an ID that is a value indicating a type of data. The ID is also referred to as a CAN ID. This ID field is used for communication arbitration when a plurality of nodes start transmission at the same time. Accordingly, a frame having a higher priority is assigned with an ID having a smaller value.

The data field is made up of maximum of 64 bits and stores data.

Each of the ECUs which transmits communication data stores, in the data field, data of a predetermined type as in-vehicle network (communication system 10) specifications, and stores a CAN ID predetermined according to this type of data into the ID field, thereby configuring a data frame of data to be transmitted. The CAN ID for use in communication data and the corresponding data structure, etc. are determined in advance as the in-vehicle network (communication system 10) specifications by, for example, a vehicle manufacturer.

[1.3 Configuration of Communication Device 101]

Next, a configuration of the communication device 101 is described in detail.

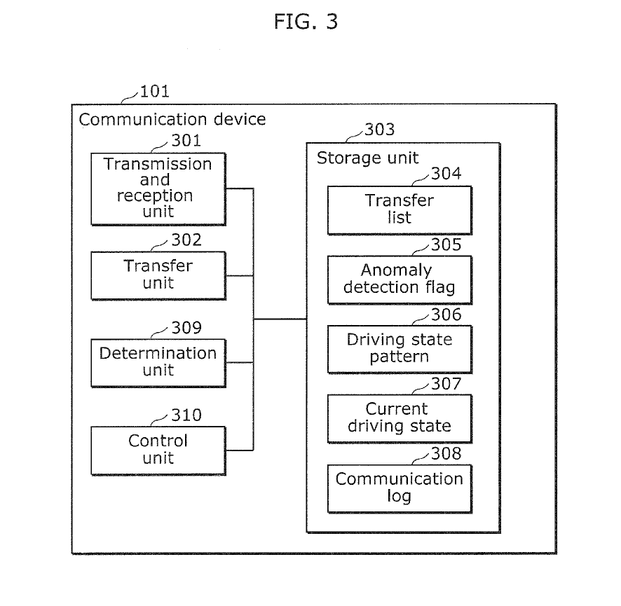

FIG. 3 is a diagram which illustrates a configuration of the communication device 101 according to Embodiment 1. The communication device 101 includes a transmission and reception unit 301, a transfer unit 302, a storage unit 303, a determination unit 309, and a control unit 310, as illustrated in FIG. 3.

Although not specifically illustrated, the communication device 101 includes a microprocessor, a RAM, a ROM, a hard disk, etc. The RAM, the ROM, and the hard disk each store a computer program. The microprocessor operates according to the computer program, thereby allowing the communication device 101 to perform the function.

It should be noted that the functional blocks of the communication device 101, such as the transmission and reception unit 301, the transfer unit 302, the storage unit 303, the determination unit 309, and the control unit 310, are typically implemented as an LSI which is an integrated circuit. They may be realized as a single chip one-by-one, or as a single chip to include at least one of the functional blocks or part of all of the functional blocks.

Alternatively, the functional block included by the monitoring ECU 103 and each of the functional blocks included by the communication device 101 may be realized as a single chip.

Although an LSI is mentioned here, the integrated circuit may be referred to as an IC, a system LSI, a super LSI, or an ultra LSI depending on the scale of integration.

Moreover, ways to achieve integration are not limited to the LSI, and a dedicated circuit or a general purpose processor and so forth can also achieve the integration. Field Programmable Gate Array (FPGA) that can be programmed after manufacturing LSIs or a reconfigurable processor that allows re-configuration of the connection or settings of circuit cells inside an LSI may be used for the same purpose.

Furthermore, in the future, with advancement in semiconductor technology, a brand-new technology may replace LSI. The functional blocks can be integrated using such a technology. There can be a possibility of adaptation of biotechnology, for example.

Moreover, each of the functional blocks may be implemented as a software program or a combination of an LSI and a software program. Here, the software program may be tamper resistant.

(1) Transmission and Reception Unit 301

The transmission and reception unit 301 is connected to the external communication ECU 102. The transmission and reception unit 301, after receiving communication data passing through the CAN buses 105, transmits the received communication data to a device external to the vehicle. Alternatively, the transmission and reception unit 301, after receiving communication data transmitted from a device external to the vehicle, transmits the received communication data to the CAN buses 105. The transmission and reception unit 301 is one example of a transmitter which transmits communication data on which sampling is performed, to a device external to the vehicle.

(2) Transfer Unit 302

The transfer unit 302 determines, based on a transfer list 304 which will be described later, CAN bus 105 to which the communication data received by transmission and reception unit 301 is to be transferred, and transmits (transfers) the communication data to CAN bus 105 determined, via the transmission and reception unit 301.

(3) Storage Unit 303

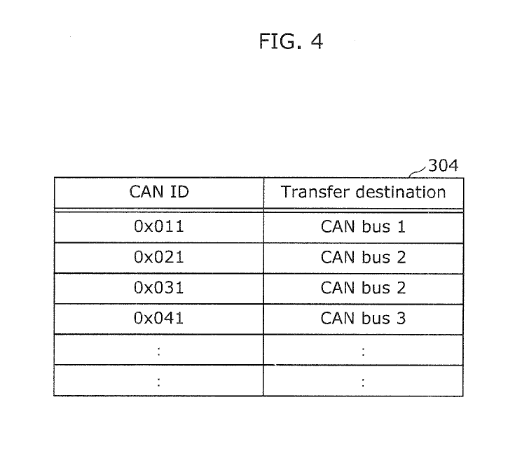

The storage unit 303 stores a transfer list 304 in which a CAN ID assigned to communication data is paired with one of the CAN buses 105 that is a transfer destination to which the communication data is to be transferred, the anomaly detection flag 305 indicating whether a state of the in-vehicle network (e.g., each of the CAN buses 105) is in an anomalous state, the driving state pattern 306 in which a sampling rate according to a driving state is described as a sampling method corresponding to the driving state, the current driving state 307 of the vehicle, and a communication log 308 that is communication data for each of the CAN buses 105. FIG. 4 illustrates one example of the transfer list 304.

FIG. 4 is a diagram which illustrates one example of the transfer list 304 according to Embodiment 1.

As illustrated in FIG. 4, in the transfer list 304, a CAN ID assigned to communication data is paired with one of the CAN buses 105 which is the transfer destination to which the communication data is to be transferred. The example illustrated in FIG. 4 indicates that communication data assigned with a CAN ID of “0x011” is transferred to CAN bus 1, communication data assigned with a CAN ID of “0x021” and a CAN ID of “0x031” are transferred to CAN bus 2, and communication data assigned with a CAN ID of “0x041” is transferred to CAN bus 3. The following describes CAN bus 1 as a CAN bus 105a, CAN bus 2 as a CAN bus 105b, and CAN bus 3 as a CAN bus 105c.

An anomaly detection flag 305 comprises a plurality of flags respectively associated with the CAN buses 105 and each indicating whether the associated CAN bus is normal. For example, the flag takes a value 0 when the associated CAN bus 105 is normal, and takes a value 1 when the associated CAN bus 105 is anomalous. For example, suppose that the monitoring ECU 103 performs normal/anomaly determination on communication data, and determines that the CAN bus 105a and the CAN bus 105c are anomalous, and the CAN bus 105b is normal. In this case, the monitoring ECU 103 notifies the communication device 101 accordingly. Communicate device 101, according to notification received from the monitoring ECU 103, sets to 1 the anomaly detection flags associated with the CAN bus 105a and the CAN bus 105c which are determined as being anomalous, and sets to 0 the anomaly detection flag associated with CAN bus 105b which is determined as being normal.

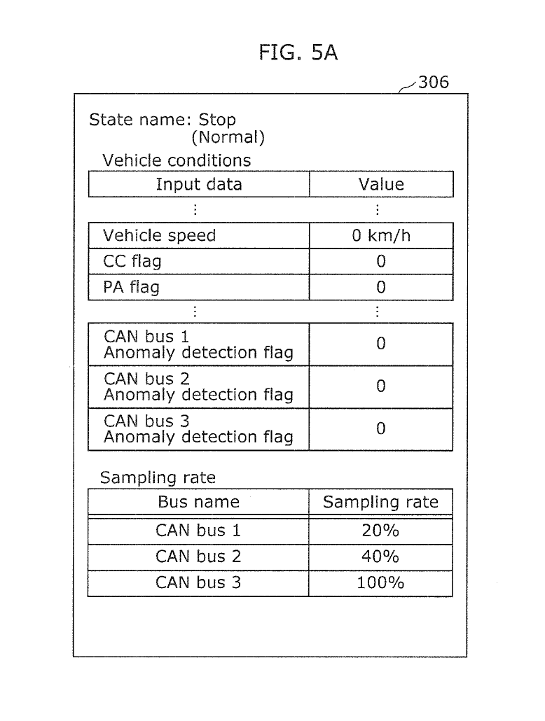

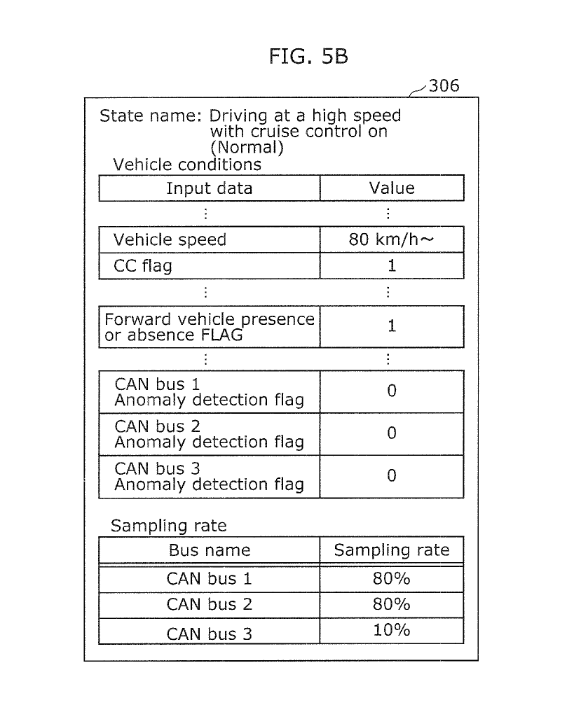

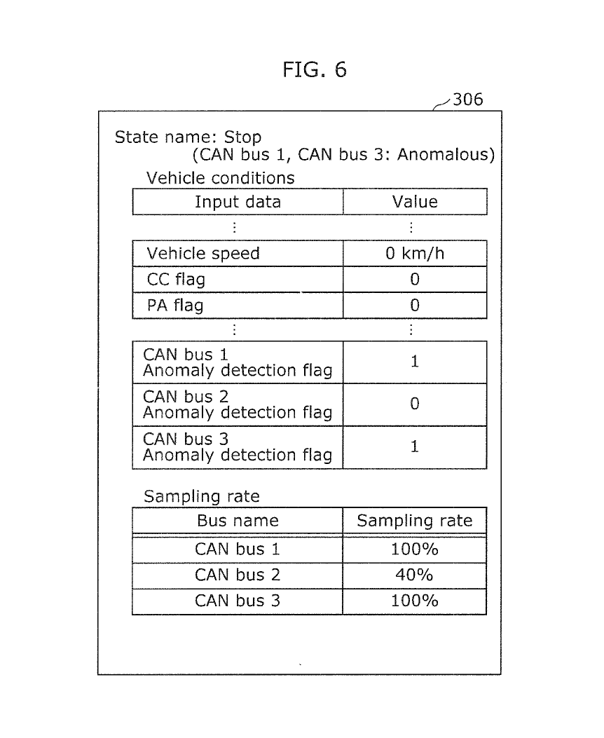

The driving state pattern 306 indicates a method of performing sampling on communication data. Various driving state patterns 306 are predetermined according to various driving states. A driving state is defined so as to correspond to details of the communication data (a speed of the vehicle, ON/OFF of the ADAS functions, a result of determination on whether the network is in a normal state or an anomalous state, or the like) received from CAN bus 105. FIG. 5A, FIG. 5B, and FIG. 6 illustrate examples of the driving state pattern 306.

FIG. 5A is a diagram which illustrates one example of a driving state pattern corresponding to a normal driving state according to Embodiment 1.

FIG. 5A illustrates the driving state pattern 306 as a driving state of a vehicle when the vehicle is stopped and the in-vehicle network is free of anomalies. More specifically, FIG. 5A illustrates the driving state pattern 306 having a state name of stop (normal) when a vehicle speed is 0 km/h, all of the ADAS functions are OFF; that is, cruise control (CC), parking assist (PA), etc. are all off (CC flag=0 and PA flag=0), and each of the CAN buses 105 is free of anomalies (anomaly detection flag=0).

FIG. 5B is a diagram which illustrates another example of the driving state pattern corresponding to the normal driving state according to Embodiment 1.

FIG. 5B illustrates the driving state pattern 306 as a driving state of a vehicle when the vehicle is driving at a high speed with cruise control on, and the state of the in-vehicle network is free of anomalies. More specifically, FIG. 5B illustrates the driving state pattern 306 having a state name of driving at a high speed with cruise control on (normal) when a vehicle speed is at least 80 km/h, cruise control (CC) is on (CC flag=1), a vehicle is present forward (forward vehicle presence or absence flag=1), and each of the CAN buses 105 is free of anomalies (anomaly detection flag=0).

FIG. 6 is a diagram which illustrates one example of the driving state pattern 306 corresponding to an anomalous driving state according to Embodiment 1.

FIG. 6 illustrates the driving state pattern 306 as a driving state of a vehicle when the vehicle is stopped and the in-vehicle network is in an anomalous state. More specifically, FIG. 6 illustrates the driving state pattern 306 having a state name of stop (CAN bus 1 and CAN bus 3 are anomalous) when a vehicle speed is 0 km/h, all of the ADAS functions are OFF; that is, cruise control (CC), parking assist (PA), etc. are all off (flags=0), and CAN bus 1 (CAN bus 105a) and CAN bus 3 (CAN bus 105c) are anomalous (anomaly detection flag=1).

With the sampling method as indicated by the driving state pattern 306, a sampling rate is determined for each group including one or more ECUs 104 among the plurality of ECUs 104. For example, in the in-vehicle network, the plurality of ECUs 104 are connected one another by the CAN buses 105 in a vehicle, and the group includes one or more ECUs 104 connected to the same CAN bus 105 among the CAN buses 105. In other words, a sampling rate is determined for each of a group of the CAN bus 105a, a group of the CAN bus 105b, and a group of the CAN bus 105c.

The sampling rate is defined, for each of the CAN buses 105, in various driving state patterns 306 predetermined for various driving states such that communication data which is highly important is transmitted by a large amount to the device external to the vehicle (i.e., such that the sampling rate is increased) and an amount of transmitting communication data which is of low importance to the device external to the vehicle is reduced (i.e., such that the sampling rate is decreased). All the communication data received by the transmission and reception unit 301 of the communication device 101 is subjected to sampling for each of the CAN buses 105 according to the sampling rate defined in the driving state pattern 306.

For example, when the vehicle is stopped and the ADAS function is off (specifically, under the vehicle conditions indicated by the driving state pattern 306 in FIG. 5A), a value of communication data of a driving system such as the vehicle speed, the number of engine rotation, etc. barely changes. Accordingly, it can be said that communication data with less changes such as the vehicle speed, the number of engine rotation, etc. barely includes meaningful information. In other words, it can be said that, in this case, meaningful communication data is not passing through the CAN bus 105a to which the ECUs 104 related to the ADAS are connected and the CAN bus 105b to which the ECUs 104 related to the powertrain are connected. Meanwhile, there is a possibility of change in communication data related to the body, such as information indicating an opened/closed state of the door or information indicating a door-lock state. In other words, in this case, it can be said that meaningful communication data is passing through the CAN bus 105c to which the ECUs 104 related to the body of the vehicle. In other words, it can be said that, in the state where the vehicle is stopped, it is more beneficial in terms of analyzing communication data, to transmit, to the server device 11, communication data of the CAN bus 105c through which communication data related to the body system is transmitted, than communication data of the CAN bus 105a or 105b through which communication data related to the driving system is transmitted. As described above, the driving state pattern 306 is defined such that a higher sampling rate is provided to the CAN bus 105 that includes, by a large amount, meaningful communication data according to the driving state of the vehicle.

Furthermore, the sampling rate is also defined according to a value of the anomaly detection flag 305. In order to detect an attack such as transmission of an unauthorized message by an attacker and to establish a procedure for determining whether it is an attack, the sampling rate is defined such that communication data of a CAN bus 105 that is not normal; that is, communication data of a CAN bus 105 of which a value of the anomaly detection flag 305 is 1 is all extracted and transmitted to the server device 11. For example, as illustrated in FIG. 6, the sampling rate of each of the CAN buses 105a and 105c of which the value of the anomaly detection flag 305 is 1 is 100%.

The current driving state 307 is information which indicates a current state of the vehicle including a normal or anomalous state of the in-vehicle network, and determined by the determination unit 309 which will be described later, based on communication data received by the transmission and reception unit 301. When there is a change in communication data received, and the current driving state 307 which is determined does not satisfy the vehicle conditions indicated in the driving state pattern 306 that is selected last time from among a plurality of driving state patterns 306, the driving state pattern 306 selected last time is updated to the driving state pattern 306 that corresponds to the current driving state 307. The details will be described later.

The communication log 308 is communication data for each of the CAN buses 105, and the communication data on which sampling is performed according to the sampling rate defined in the driving state pattern 306 is recorded on the storage unit 303. It is sufficient that the communication data on which sampling is performed is transmitted to at least the server device 11. Although the storage capacity of the storage unit 303 increases, communication data before sampling is performed may be stored in the storage unit 303.

(4) Determination Unit 309

The determination unit 309 is one example of a first determination unit, and determines, based on communication data passing through the network to which a plurality of ECUs 104 in a system (vehicle) are connected, an operating state of the system (specifically, a driving state of the vehicle, namely, a current driving state 307). In addition, the determination unit 309 determines whether the network is in a normal state. More specifically, the determination unit 309 determines whether each CAN bus 105 is normal or anomalous, based on a result of determination which is performed by the monitoring ECU 103 as to whether the in-vehicle network (specifically, CAN bus 105) is in a normal state or an anomalous state, and is received via the transmission and reception unit 301. For example, the determination unit 309 determines whether the network is in a normal state, by determining whether a message included in the communication data is normal. Alternatively, the determination unit 309 determines whether the network is in a normal state, by determining whether the CAN bus 105 in the network is normal, for example. It should be noted that the monitoring ECU 103 originally performs these determinations, and the determination unit 309 receives results of these determinations from the monitoring ECU 103, and thus it is possible for the determination unit 309 to perform these determinations. In addition, the determination unit 309 determines that whether the current driving state 307 determined based on the communication data received via the transmission and reception unit 301 satisfies the vehicle conditions indicated in the selected driving state pattern 306.

(5) Control Unit 310

The control unit 310 manages and controls each of the functional blocks described in (1) to (4) above. The control unit 310 is one example of a first control unit, and performs sampling on communication data according to a sampling method corresponding to the operating state determined by the determination unit 309. For example, the control unit 310 selects, from among the plurality of driving state patterns 306, the driving state pattern 306 which corresponds to the current driving state 307 determined by the determination unit 309 according to the communication data received by the CAN bus 105 and the anomaly detection flag 305. It should be noted that switching from a driving state pattern 306 selected last time to a different driving state pattern 306 by selecting a driving state pattern 306 corresponding to the current driving state 307 from among the plurality of driving state patterns 306 is also referred to as updating of the driving state pattern 306. The control unit 310 performs sampling on the communication data passing through each of the CAN buses 105, according to the sampling rate defined in the latest driving state pattern 306 which has been updated, for example, and stores the communication data on which sampling has been performed, as a communication log 308, in the storage unit 303 for each of the CAN buses 105.

[1.4 Other Example of Group]

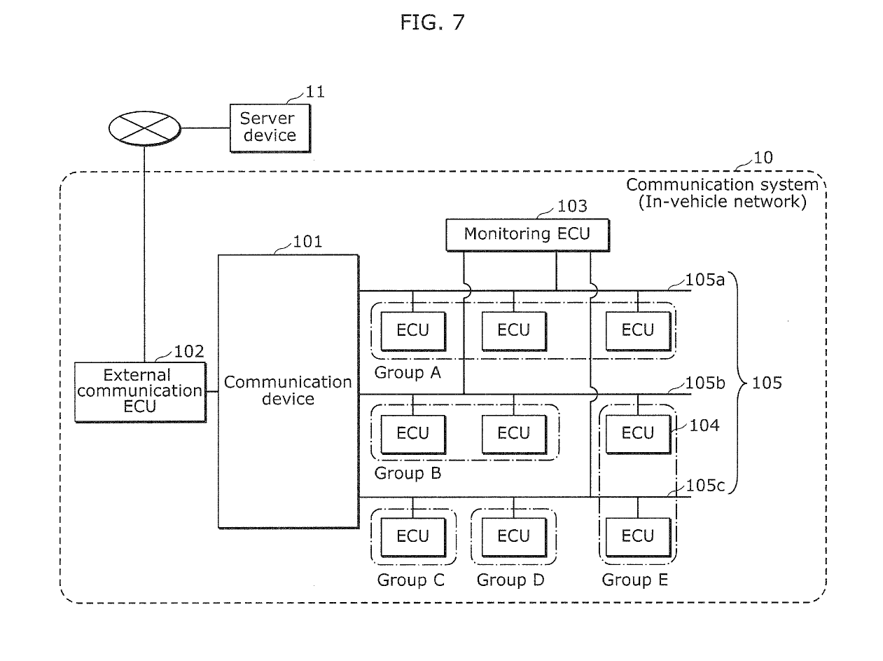

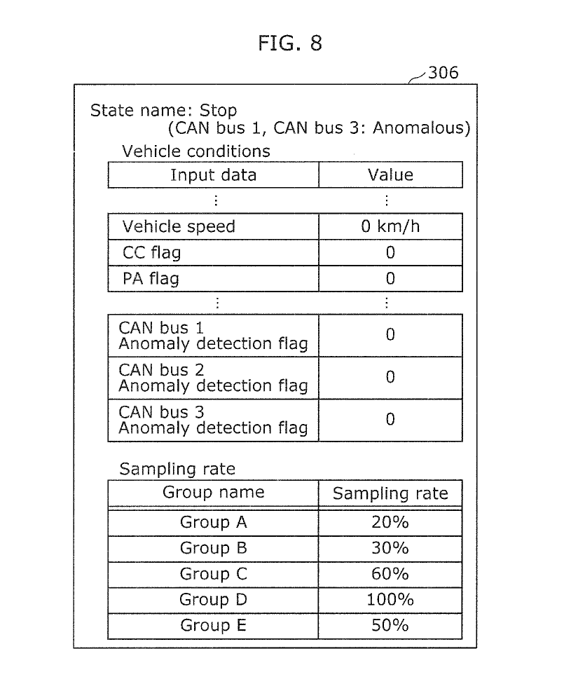

The sampling rate defined in the driving state pattern 306 is determined for each of the groups respectively corresponding to the CAN buses 105. However, the present disclosure is not limited to this example. The following describes this with reference to FIG. 7 and FIG. 8.

FIG. 7 is a diagram which illustrates another example of the group according to Embodiment 1. FIG. 8 is a diagram which illustrates another example of the driving state pattern corresponding to the normal driving state according to Embodiment 1.

For example, the group for which a sampling rate is determined need not be composed of only the ECUs 104 connected to the same CAN bus 105. The group may be such a group as a group E illustrated in FIG. 7. Alternatively, as groups C and D illustrated in FIG. 7, even when the ECUs 104 connected to the same CAN bus 105 may be grouped into different groups. For example, the group for which a sampling rate is determined may be composed of one or more ECUs 104 which transmit a message (e.g., the same CAN ID, or data on related CAN ID) included in communication data and related to the same function. For example, the ECU 104 connected to the CAN bus 105b and the ECU 104 connected to the CAN bus 105c in the group E transmit message related to the same function. The ECUs which transmit messages related to the same function are, for example, a rudder angle sensor ECU and a power steering ECU, etc. Since these ECUs both transmit messages related to steering, they belong to the same group. The sampling rate may be defined for each of such groups A to E in the driving state pattern 306 as illustrated in FIG. 8, instead of the groups determined to correspond to the respective CAN buses 105.

It should be noted that, in the following description, the groups are described as groups determined to correspond to the respective CAN buses 105.

[1.5 Operation of Communication System 10]

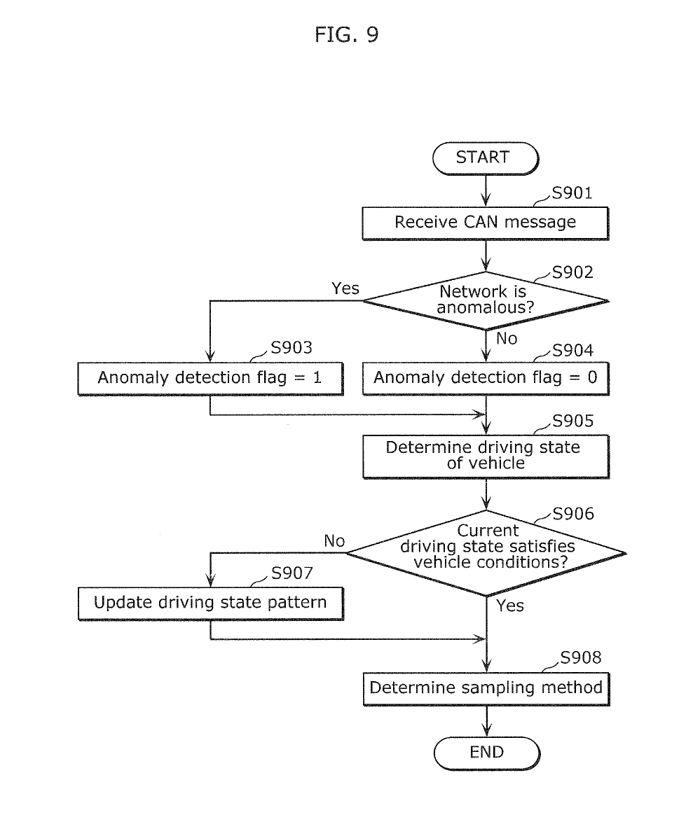

The following describes, with reference to FIG. 9 to FIG. 11, one example when the communication system 10 uses communication data received from the CAN buses 105 to perform sampling on the communication data for each of the CAN buses 105 according to a driving state of a vehicle, and transmits the communication data on which the sampling has been performed, to the server device 11.

First, a procedure of determining a sampling method will be described with reference to FIG. 9.

FIG. 9 is a flowchart which illustrates one example of a procedure of determining a sampling method according to Embodiment 1.

First, in Step S901, the communication device 101 receives, by the transmission and reception unit 301, communication data transmitted from the monitoring ECU 103 and the plurality of ECUs 104. For example, the communication data transmitted from the monitoring ECU 103 includes a result of determination on whether the network is in a normal state (specifically, a result of determining, for each of the CAN buses 105, whether the CAN bus 105 is normal). In addition, the communication data transmitted from the plurality of ECUs 104 includes data for determining a driving state of the vehicle.

Next, in Step S902, the determination unit 309 determines whether the communication data transmitted from the monitoring ECU 103 includes a notification indicating an anomaly of the CAN bus 105. When the determination unit 309 determines that the communication data includes the notification indicating an anomaly of the CAN bus 105 (Yes in Step S902); that is, when the state of the network is anomalous, the procedure of determining proceeds to Step S903. When the determination unit 309 determines that the communication data does not include the notification indicating an anomaly of the CAN bus 105 (No in Step S902), the procedure of determining proceeds to Step S904.

In Step S903, the control unit 310 of the communication device 101 sets to 1 a value of the anomaly detection flag 305 corresponding to the CAN bus 105 whose anomaly has been notified.

On the other hand, in Step S904, the control unit 310 of the communication device 101 sets to 0 a value of the anomaly detection flag 305 corresponding to the CAN bus 105 whose anomaly has not been notified.

Next, in Step S905, the determination unit 309 determines a driving state of the vehicle (the current driving state 307), based on the communication data received from the plurality of ECUs 104 and the value of the anomaly detection flag 305. For example, the determination unit 309 determines, based on the communication data received from the plurality of ECUs 104 and the value of the anomaly detection flag 305, the current driving state 307 which indicates whether the vehicle is currently driving or stopped, whether the in-vehicle network is in a normal state or an anomalous state, etc.

In Step S906, the determination unit 309 determines whether the current driving state 307 satisfies the vehicle conditions indicated in the driving state pattern 306 selected last time. When the determination unit 309 determines that the current driving state 307 does not satisfy the vehicle conditions (No in Step S906), the procedure of determining proceeds to Step S907. When the determination unit 309 determines that the current driving state 307 satisfies the vehicle conditions (Yes in Step S906), the procedure of determining proceeds to Step S908.

In Step S907, the control unit 310 selects, from among a plurality of driving state patterns 306, a driving state pattern 306 including vehicle conditions which the current driving state 307 satisfies; that is, the control unit 310 updates the driving state pattern 306.

For example, assume that a previously determined driving state indicates that the vehicle speed is at least 80 m km/h, the CC flag is 1, the forward vehicle presence or absence flag is 1, the anomaly detection flag 305 of each of the CAN buses 105 is 0, and that the driving state pattern 306 illustrated in FIG. 5B is selected at the start of the flowchart illustrated in 9. Then the driving state of the vehicle changes, and the current driving state 307 in Step S906 indicates that the vehicle speed is 0 km/h, the CC flag is 0, the PA flag is 0, the anomaly detection flag 305 of each of the CAN buses 105 is 0. In this case, the current driving state 307 does not satisfy the vehicle conditions indicated in the driving state pattern 306 illustrated in FIG. 5B. Accordingly, in Step S907, the driving state pattern 306 is updated to the driving state pattern 306 illustrated in FIG. 5A as the driving state pattern 306 that satisfies the current driving state 307, from among the plurality of driving state patterns 306.

In Step S908, the control unit 310 determines the sampling method for the communication data. More specifically, the control unit 310 determines a sampling method with a sampling rate indicated by the selected driving state pattern 306 being defined. In other words, the control unit 310 determines a sampling method of performing sampling on communication data passing through each of the CAN buses 105, at a sampling rate defined in the driving state pattern 306.

It should be noted that, although the state of the in-vehicle network (the state whether the CAN bus 105 is normal) is also a part of the driving state of the vehicle in the description provided thus far, the driving state of the vehicle need not include the state of the in-vehicle network. In this case, information on the anomaly detection flag 305 is not included in the driving state pattern 306.

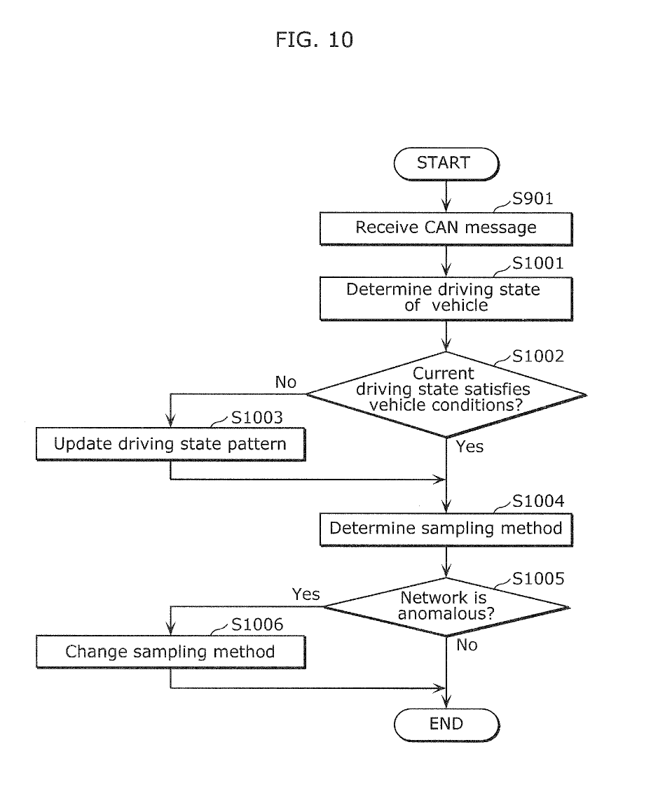

Accordingly, the driving state pattern 306 of the case where the in-vehicle network is anomalous as illustrated in FIG. 6 does not exist. In addition, in this case, the determination unit 309 determines the driving state of the vehicle, not based on the result of determination on whether the network is in a normal state. A procedure of determining a sampling method in this case will be described with reference to FIG. 10.

FIG. 10 is a flowchart which illustrates another example of the procedure of determining a sampling method according to Embodiment 1.

First, in Step S 901, the communication device 101 receives, by the transmission and reception unit 301, communication data transmitted from the monitoring ECU 103 and the plurality of ECUs 104. For example, the communication data transmitted from the monitoring ECU 103 includes a result of determination on whether the network is in a normal state (specifically, a result of determination on, for each of the CAN buses 105, whether the CAN bus 105 is normal). In addition, the communication data transmitted from the plurality of ECUs 104 includes data for determining a driving state of the vehicle.

Next, in Step S1001, the determination unit 309 determines a driving state of the vehicle (the current driving state 307), based on the communication data received from the plurality of ECUs 104. For example, the determination unit 309 determines, based on the communication data received from the plurality of ECUs 104, the current driving state 307 which indicates whether the vehicle is currently driving or stopped, etc. In Step S905 illustrated in FIG. 9, the determination unit 309 determines the current driving state 307 based also on a value of the anomaly detection flag 305, and also determines, for example, the current driving state 307 indicating whether the in-vehicle network is in a normal state or an anomalous state, based on the value of the anomaly detection flag 305. In other words, in Step S1001 illustrated in FIG. 10, the determination unit 309 determines the driving state of the vehicle not based on the result of determination on whether the network is in a normal state.

In Step S1002, the determination unit 309 determines whether the current driving state 307 satisfies the vehicle conditions indicated in the driving state pattern 306 selected last time. When the determination unit 309 determines that the current driving state 307 does not satisfy the vehicle conditions (No in Step S1002), the procedure of determining proceeds to Step S1003. When the determination unit 309 determines that the current driving state 307 satisfies the vehicle conditions (Yes in Step S1002), the procedure of determining proceeds to Step S1004.

In Step S1003, the control unit 310 selects, from among a plurality of driving state patterns 306, a driving state pattern 306 including vehicle conditions which the current driving state 307 satisfies. In other words, the control unit 310 updates the driving state pattern 306.

In Step S1004, the control unit 310 determines the sampling method for the communication data. More specifically, the control unit 310 determines a sampling method with a sampling rate indicated by the selected driving state pattern 306 being defined. In other words, the control unit 310 determines a sampling method of performing sampling on communication data passing through each of the CAN buses 105 at a sampling rate defined in the driving state pattern 306.

Next, in Step S1005, the determination unit 309 determines whether the communication data transmitted from the monitoring ECU 103 includes a notification indicating an anomaly of the CAN bus 105. When the determination unit 309 determines that the communication data includes the notification indicating an anomaly of the CAN bus 105 (Yes in Step S1005); that is, when the network is in an anomalous state, the procedure of determining proceeds to Step S1006. When the determination unit 309 determines that the communication data does not include the notification indicating an anomaly of the CAN bus 105 (No in Step S1005), the procedure of determining the sampling method is finished.

In Step S1006, the control unit 310 changes the sampling method determined in Step S1004. More specifically, the control unit 310 changes a sampling rate corresponding to the CAN bus 105 that is anomalous, among the sampling rates for the respective CAN buses 105 in the determined sampling method. For example, the control unit 310 sets the sampling rate for the CAN bus 105 that is anomalous to 100%. More specifically, in the case where the sampling rates for the respective CAN buses 105 in the sampling method determined in Step S1004 are the sampling rates indicated in FIG. 5A, when the CAN buses 105a and 105c are anomalous, the sampling rates for the CAN buses 105a and 105c are changed to 100%. In other words, in this case, the sampling method is determined such that the sampling rates for the respective CAN buses 105 are the sampling rates indicated in FIG. 6.

As described above, the driving state pattern 306 for the case where the in-vehicle network has an anomaly need not be prepared, and the sampling method may be changed by, when the network is in an anomalous state, changing the sampling rate for the group corresponding to the anomaly in the determined sampling method.

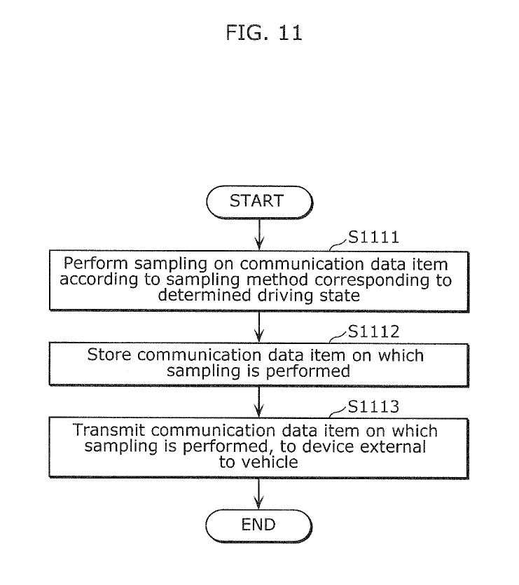

Next, an operation of the communication device 101 according to the determined sampling method (or the sampling method changed after determination) with reference to FIG. 11.

FIG. 11 is a flowchart which illustrates one example of an operation of the communication device 101 according to Embodiment 1.

First, in Step S1111, the control unit 310 performs sampling on communication data, according to a sampling method corresponding to the determined driving state (i.e., a sampling method which has been determined, or changed after determination). More specifically, the control unit 310 performs sampling on the communication data received by transmission and reception unit 301 from each of the CAN buses 105, according to the sampling rates for the respective CAN buses 105 defined in the driving state pattern 306 corresponding to the current driving state 307.

Next, in Step S1112, the control unit 310 stores in the storage unit 303 the communication log 308 as the communication data on which sampling is performed, for each of the CAN buses 105.

In Step S1113, the transmission and reception unit 301 transmits the communication data on which sampling is performed, to the server device 11.

It should be noted that a timing with which the process of Step S1113 is started is not particularly limited. For example, the process may be performed at a predetermined time interval, or in response to a request from the server device 11.

[1.6 Conclusion]

As described above, the communication device 101 according to Embodiment 1 includes: the determination unit 309 which determines an operation (driving) state of a system (vehicle), based on communication data passing through a network to which the plurality of ECUs 104 are connected in the system; the control unit 310 which performs sampling on the communication data according to a sampling method corresponding to the determined operation (driving) state; and the transmitter (transmission and reception unit 301) which transmits the communication data on which sampling is performed to the device (server device 11) external to the system (vehicle).

According to this configuration, it is possible to perform sampling according to the operation (driving) state of a vehicle or the like, in such a manner that communication data which is less important is not extracted by a large amount (i.e., to be decimated by a large amount), and communication data which is highly important is extracted by a large amount (i.e., to be not decimated by a large amount, or not decimated at all). In other words, according to the operation (driving) state of a vehicle or the like, communication data is transmitted to a device external to the vehicle, with the data amount of highly important communication data being not reduced much (or not at all reduced), and the data amount of less important communication data being reduced. Accordingly, it is possible to effectively reduce the load of communication with the external device and the storage capacity of the device. It should be noted that the communication data transmitted to a device external to the vehicle or the like can be used for failure analysis or attack analysis of a cyberattack.

In addition, the communication device 101 may further include a storage unit 303, and the control unit 310 may store, in the storage unit 303, the communication data on which sampling is performed.

With this, the communication data on which sampling is performed is stored in the storage unit 303, and thus it is possible to reduce the storage capacity of the storage unit 303.

In addition, with the above-described sampling method, a sampling rate may be determined for each group including one or more ECUs 104 among the plurality of ECUs 104, and the control unit 310 may perform sampling on communication data of each group, according to the sampling rate determined for the group.

With this, since there are instances where the degree of importance of communication data of each group differs according to the driving state of a vehicle, as in, for example, the degree of importance of communication data of a body-related ECU 104 is low when a vehicle is driving and high when the vehicle is stopped, and the degree of importance of communication data of a powertrain-related ECU 104 is high when a vehicle is driving and low when the vehicle is stopped, it is possible to effectively perform sampling on communication data for each group.

In addition, in a network, the plurality of ECUs 104 may be connected to one another by the CAN buses 105 in the system (vehicle), and the groups are each composed of one or more ECUs 104 connected to the same CAN bus 105.

For example, one or more ECUs 104 connected to the same CAN bus 105 generally have a similar function and handle similar communication data in many cases. Accordingly, it is possible to effectively perform sampling on communication data for each group composed of one or more ECUs 104 connected to the same CAN bus 105.

In addition, the group may be composed of one or more ECUs 104 each transmitting a message related to the same function and included in communication data.

With this, it is possible to effectively perform sampling on communication data for each group composed of one or more ECUs 104 each transmitting a message related to the same function.

In addition, the determination unit 309 may further determine whether the network is in a normal state, and based also on a result of the determination on whether the network is in a normal state, may determine an operation (driving) state of the system (vehicle).

With this, the driving state of the vehicle is determined based also on a result of determination on whether the network is in a normal state, and thus the sampling method also corresponds to the result of the determination on whether the network is in a normal state. Accordingly, it is possible to perform sampling on communication data also according to whether the network is in a normal state.

In addition, the determination unit 309 may further determine whether the network is in a normal state, and the control unit 310 may change the sampling method according to whether the network is in a normal state.

With this, the sampling method is changed according to a result of determination on whether the network is in a normal state, and thus it is possible to perform sampling on communication data also according to whether the network is in a normal state.

More specifically, the determination unit 309 may determine whether the network is in a normal state, by determining whether a message included in the communication data is normal.

Furthermore, in the network, the plurality of ECUs 104 are connected to one another by the CAN buses 105 in the vehicle, and the determination unit 309 may determine whether the network is in a normal state, by determining whether the CAN buses 105 in the network are normal.

### Another Aspect, Etc. Of Embodiment 1

Embodiment 1 is described thus far as an exemplification of the technique according to the present disclosure. However, the technique according to the present disclosure is not limited to the foregoing embodiment, and can also be applied to embodiments to which a change, substitution, addition, or omission is executed as necessary. For example, the following variation examples are also included in Embodiment 1 of the present disclosure.

(1) In Embodiment 1 of the present disclosure, when the monitoring ECU 103 notifies, via the CAN buses 105, the communication device 101 that unauthorized communication data is detected, the monitoring ECU 103 may attach a message authentication code (MAC) to communication data and transmit the communication data.

(2) In Embodiment 1 of the present disclosure, the monitoring ECU 103 periodically notifies the communication device 101 that the CAN buses 105 are normal or anomalous. However, the monitoring ECU 103 may notify the communication device 101 on a per event basis, such as notifying only when an anomaly is detected.

(3) In Embodiment 1 of the present disclosure, it is assumed that the communication device 101 periodically receives a notification indicating normal or anomalous of the CAN buses 105. However, determination of normal or anomalous may be carried out using a non-arrival state or the like; that is, the CAN bus 105 may be determined as being normal when a notification indicating anomalous has not been received for a predetermined period of time.

(4) In Embodiment 1 of the present disclosure, it is assumed that the communication device 101 is physically a single ECU. However, the communication device 101 may be included in another ECU such as the monitoring ECU 103, as a logically independent functional module (software).

(5) In Embodiment 1 of the present disclosure, it is assumed that the communication device 101 is a single ECU including a relaying or transferring function. However, the relaying or transferring function may be included by another ECU, such as a relay ECU.

(6) In Embodiment 1 of the present disclosure, it is assumed that communication data of a CAN bus 105, among the CAN buses 105, which is determined as being anomalous by the monitoring ECU 103 is transmitted to the server device 11 without being subjected to sampling; that is, transmitted to the server device 1 at a sampling rate of 100%. However, it may be defined that such communication data is subjected to sampling as with the CAN buses 105 determined as being normal.

(7) In Embodiment 1 of the present disclosure, the communication device 101 and the monitoring ECU 103 are mounted physically in a single ECU, but may be mounted logically as independent functional modules (e.g., software).

(8) In Embodiment 1 of the present disclosure, a communication system such as a CAN with flexible data rate (CANFD), a time triggered CAN (TTCAN), Ethernet, a local interconnected network (LIN), a media oriented systems transport (MOST), FlexRay, etc. may be employed instead of the CAN communication.

(9) A part or all of the structural components included in the communication device 101 may be configured as an IC card which can be attached and detached from the communication device 101 or as a stand-alone module. The IC card or the module is a computer system including a microprocessor, a ROM, a RAM, etc. The IC card or the module may also include the aforementioned super-multi-function LSI. The IC card or the module achieves its function through the microprocessor's operation according to the computer program. The IC card or the module may also be implemented to be tamper-resistant.

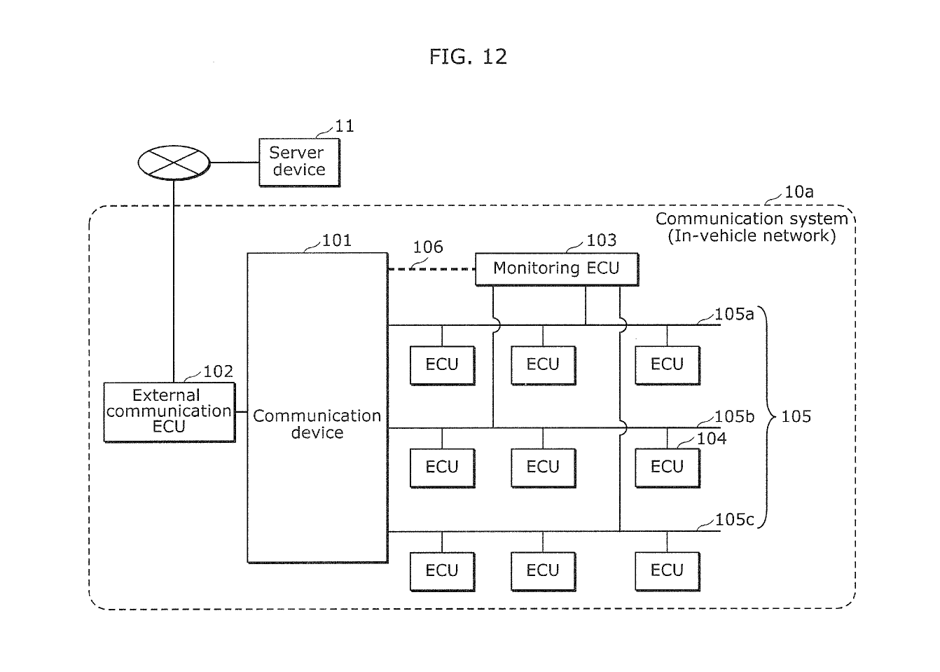

(10) In Embodiment 1 of the present disclosure, the monitoring ECU 103 notifies, via the CAN buses 105, the communication device 101 of a result of detecting normal or anomalous of communication data. However, the present disclosure is not limited to this example. This will be described below with reference to FIG. 12.

FIG. 12 is a diagram which illustrates a configuration of a communication system 10a according to another aspect of Embodiment 1.

In the communication system 10 according to Embodiment 1, the CAN buses 105 are used for transmitting and receiving communication data, as described above. In addition, the CAN buses 105 are also used for transmitting and receiving a result of determination on whether the in-vehicle network is in a normal state which is performed by the monitoring ECU 103. In contrast, in the communication system 10a, communication via a dedicated line 106 that is different from the CAN buses 105 is used for transmitting and receiving a result of determination on whether the in-vehicle network is in a normal state which is performed by the monitoring ECU 103. For example, the dedicated line 106 is a communication line which is not connected to the outside, and is strong against an attack from outside.

Suppose that an unauthorized node is connected to the CAN buses 105 and unauthorized information is transmitted to the CAN buses 105 when the CAN buses 105 are used for transmitting and receiving a result of determination on whether the in-vehicle network is in a normal state which is performed by the monitoring ECU 103.

In this case, there is a possibility that the result of the determination is subjected to tampering. In view of the above, in the transmitting and receiving the result of the determination, for example, by using communication via the dedicated line 106 that is strong against an attack from outside, it is possible to inhibit tampering with the result of the determination.

(11) The above-described Embodiment 1 and the above-described variations may respectively be combined.

(12) In the above-described Embodiment 1, an application to security measures in an in-vehicle network provided to a vehicle (automobile) has been described as an application example of the present disclosure. However, the range of application of the present disclosure is not limited to this example. For example, the present disclosure may be applied not only to automobiles but also to mobility such as construction machineries, agricultural machineries, vessels, railroads, airplanes, etc. For example, the determination unit 309 may determine an operating state of a system of not only vehicles such as automobiles but also construction machineries, agricultural machineries, vessels, railroads, and airplanes, based on communication data passing through a network to which a plurality of electronic control units are connected in the system. In addition, the control unit 310 may perform sampling on communication data, according to a sampling method corresponding to the determined operating state. Furthermore, the transmitter (transmission and reception unit 301) may transmit communication data on which sampling is performed to a device external to the system.

It should be noted that, in order to effectively reduce the load of communication with an external device and the storage capacity of the device, the first determination unit may determine an anomaly level of communication data passing through a network to which a plurality of electronic control units are connected in a system, based on the communication data. The first control unit may change at least one of a method of transmitting a log of the communication data and a method of storing the log of the communication data, according to an anomaly level of the communication data which is determined by the first determination unit. This will be described in Embodiments 2 and 3.

### Outline of Embodiments 2 and 3

A monitoring device according to one aspect of the present disclosure is a monitoring device which is mounted in a vehicle and monitors an in-vehicle network and includes a first communication unit which obtains communication data on the in-vehicle network, a second communication unit which communicates with a server via a network different from the in-vehicle network, a first storage unit which stores a log of the communication data, a first control unit which controls the first communication unit, the second communication unit, and the first storage unit. The first control unit includes a first determination unit which determines an anomaly level of the communication data from among a plurality of anomaly levels including anomalous, normal, and indeterminable, and changes at least one of a method of transmitting a log of the communication data to the server and a method of storing a log of the communication data, according to the determined anomaly level.

According to this configuration, it is possible to determine an anomaly level of communication data, from among a plurality of anomaly levels including anomalous, normal, and indeterminable, by a monitoring device mounted in a vehicle. Accordingly, since, in the case where the monitoring device cannot determine whether the communication data is anomalous or normal with accuracy, it is not necessarily required to make determination as being anomalous or normal, it is possible to reduce erroneous determination on an anomaly level by the monitoring device, and to improve accuracy in determining the anomaly level. In addition, since it is possible to change at least one of the method of transmitting a log of communication data to the server and the method of storing the log of communication data, according to the determined anomaly level of the communication data, it is also possible to reduce the amount of communication and/or the capacity of the storage device.

In addition, in the monitoring device according to one aspect of the present disclosure, the first determination unit may extract a feature value from the communication data item, and determine the anomaly level of the communication data item using the feature value extracted.

According to this configuration, it is possible to determine an anomaly level of communication data, using a feature value. Accordingly, it is possible to improve accuracy in determining the anomaly level, by using an appropriate feature value.

In addition, in the monitoring device according to one aspect of the present disclosure, the first communication unit may obtain a plurality of communication data items including the communication data item, and the first determination unit may extract, as a first feature value included in the feature value, a value included in at least one communication data item having a predetermined identifier, among the plurality of communication data items.

In addition, in the monitoring device according to one aspect of the present disclosure, the first communication unit may obtain a plurality of communication data items including the communication data item, and the first determination unit may extract, as a second feature value included in the feature value, an amount of change in a value included in each of at least two communication data items having a predetermined identifier, among the plurality of communication data items.

In addition, for example, in the monitoring device according to one aspect of the present disclosure, the first communication unit may obtain a plurality of communication data items including the communication data item, and the first determination unit may extract, as a third feature value included in the feature value, a time difference between transmission time points of at least two communication data items each having a predetermined identifier, among the plurality of communication data items.

According to this configuration, various feature values can be used for determination of an anomaly level, and thus it is possible to improve accuracy in determining the anomaly level.

In addition, in the monitoring device according to one aspect of the present disclosure, the first control unit may further include a first communication control unit configured to control the second communication unit, and the first communication control unit may: transmit the log of the communication data item to the server when the anomaly level of the communication data item is determined as being anomalous; avoid transmitting the log of the communication data item to the server when the anomaly level of the communication data item is determined as being normal; and when the anomaly level of the communication data item is determined as being indeterminable, (i) transmit a feature value of the communication data item to the server, and (ii) transmit the log of the communication data item to the server when a result of determination indicating that the anomaly level of the communication data item is black is received from the server.

According to this configuration, it is possible to transmit a feature value of communication data to the server when the anomaly level of the communication data is determined as being indeterminable. Subsequently, when a result of determination indicating anomalous as the anomaly level of the communication data is received from the server, the log of the communication data can be transmitted to the server. Accordingly, it is possible to transmit, as necessary, a log of the communication data whose anomaly level cannot be determined by the monitoring device, based on a result of determination performed by the server. It is therefore possible to reduce the amount of communication.

In addition, in the monitoring device according to one aspect of the present disclosure, the monitoring device may further include: a second storage unit for temporarily storing the log of the communication data item, wherein the first control unit may further include a storage control unit configured to control the first storage unit and the second storage unit, and the storage control unit may: store the log of the communication data item in the first storage unit when the anomaly level of the communication data item is determined as being anomalous; and when the anomaly level of the communication data item is determined as being indeterminable, (i) store the log of the communication data item in the second storage unit, (ii-1) transfer, to the first storage unit, the log of the communication data item stored in the second storage unit when a result of determination indicating that the anomaly level of the communication data item is anomalous is received from the server, and (ii-2) delete the log of the communication data item when a result of determination indicating that the anomaly level of the communication data item is normal is received from the server.

According to this configuration, it is possible, when the anomaly level of the communication data is determined as being indeterminable, (i) to temporarily store a log of the communication data in the second storage unit, and (ii) to transfer, to the first storage unit, the log of the communication data stored in the second storage unit when a result of determination that indicates anomalous as the anomaly level of the communication data is received from the server. Accordingly, it is possible to store a log of the communication data whose anomaly level cannot be determined by the monitoring device, as necessary, based on a result of determination performed by the server, and to reduce the capacity of the storage device.

In addition, in the monitoring device according to one aspect of the present disclosure, the first communication unit may obtain a plurality of communication data items including the communication data item, the first storage unit may sort the plurality of communication data items by the anomaly level determined for each of the plurality of communication data items, and store, as monitoring data items, the plurality of communication data items sorted, the first control unit may further include a first communication control unit configured to control the second communication unit, and the first communication control unit may: obtain a data amount of the monitoring data items stored in the first storage unit, for each of the plurality of anomaly levels; and transmit, to the server, the monitoring data items according to the data amount, for each of the plurality of anomaly levels.

According to this configuration, it is possible to transmit, for each of the anomaly levels, monitoring data to the server according to the data amount. Accordingly, a frequency of transmitting monitoring data can be controlled, and thus it is possible to reduce the amount of communication.

In addition, in the monitoring device according to one aspect of the present disclosure, the first communication control unit may: weight the data amount using a first weight value for each of the plurality of anomaly levels, the first weight value corresponding to the anomaly level; and transmit, for each of the plurality of anomaly levels, the monitoring data items to the server when the data amount weighted is greater than a predetermined threshold.

According to this configuration, it is possible to weight a data amount using a first weight value corresponding to an anomaly level. Accordingly, the frequency of transmitting monitoring data can be controlled according to the anomaly level, and thus it is possible to transmit monitoring data according to the degree of importance of monitoring.

In addition, in the monitoring device according to one aspect of the present disclosure, the first control unit may further include a driving state estimation unit configured to estimate a driving state of the system, and the first communication control unit may use a second weight value in addition to the first weight value in weighting the data amount, the second weight value corresponding to the driving state estimated.

According to this configuration, it is possible to use a second weight value corresponding to an estimated driving state for weighting a data amount, in addition to the first weight value. Accordingly, the frequency of transmitting monitoring data can be controlled according to the driving state of the vehicle, and thus it is possible to transmit monitoring data according to the degree of importance of monitoring.

A monitoring system according to one aspect of the present disclosure is a monitoring system which monitors an in-vehicle network, and includes the above-described monitoring device and a server which is capable of communicating with the monitoring device.

With this, it is possible to yield the advantageous effects equivalent to the advantageous effects yielded by the above-described monitoring device.

In addition, in the monitoring system according to one aspect of the present disclosure, the first control unit may further include a first communication control unit configured to control the second communication unit, and the first communication control unit may: transmit the log of the communication data item to the server when the anomaly level of the communication data item is determined as being anomalous; avoid transmitting the log of the communication data item to the server when the anomaly level of the communication data item is determined as being normal; and when the anomaly level of the communication data item is determined as being indeterminable, (i) transmit a feature value of the communication data item to the server, and (ii) transmit the log of the communication data item to the server when a result of determination indicating that the anomaly level of the communication data item is black is received from the server. The sever may include a third communication unit which communicates with the monitoring device via the network, a third storage unit which stores the log of the communication data received from the monitoring device, and a second control unit which controls the third communication unit. The second control unit may include: a second determination unit which, when the third communication unit receives from the monitoring device a feature value of the communication data whose anomaly level is determined as being indeterminable, determines whether the anomaly level the communication data is normal or anomalous, using the received feature value of the communication data; and a second communication control unit which (i) transmits a result of determination performed by the second determination unit, to the monitoring device, and (ii) receives the log of the communication data from the monitoring device when the anomaly level of the communication data is determined as being anomalous. The third storage unit may further store a learning model for determining an anomaly level of the communication data, and the second determination unit may determine the anomaly level of the communication data as being normal or anomalous based on the learning model.

According to this configuration, it is sufficient for the server to determine whether an anomaly level is anomalous or normal, for the communication data item whose anomaly level is determined as being indeterminable by the monitoring device. Accordingly, it is possible to reduce the load of the server for determining the anomaly level. In addition, the server is capable of determining an anomaly level of communication data item, using the learning model, and thus it is possible to determine the anomaly level with higher accuracy.

In addition, for example, in the monitoring system according to one aspect of the present disclosure, the first communication control unit of the monitoring device may transmit a feature value of the communication data to the server when an anomaly level of the communication data is determined as being normal, and the second control unit of the server may include a model updating unit which, when the third communication unit receives from the monitoring device the feature value of the communication data whose anomaly level is determined as being normal, updates the learning model using the feature value as training data labeled as normal.

According to this configuration, server is capable of updating a learning model, using a feature value of communication data determine as being normal. Accordingly, it is possible to establish a learning model having a higher determination accuracy, and thus to flexibly address changes in an environment.

### Embodiment 2

(Configuration of Monitoring System)

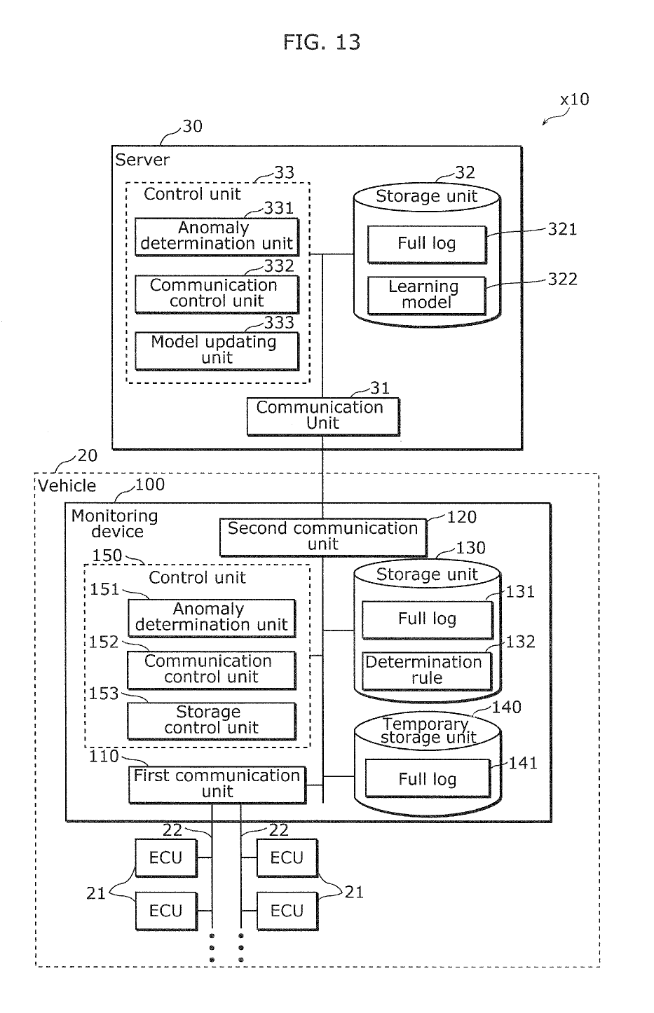

First, a configuration of a monitoring system according to Embodiment 2 will be described in detail with reference to FIG. 13. FIG. 13 is a block diagram which illustrates a functional configuration of a monitoring system x10 according to Embodiment 2.

The monitoring system x10 monitors an in-vehicle network. The monitoring system x10 includes a monitoring device 100 mounted on a vehicle 20 and a server 30 capable of communicating with the monitoring device 100. The vehicle 20 is an automobile, for example, and its motor and fuel are not particularly limited.

[Configuration of Monitoring Device]

The monitoring device 100 is mounted on the vehicle 20, and monitors the in-vehicle network. According to the present embodiment, the in-vehicle network is a communication network established in the vehicle 20 based on a controller are network (CAN). In the in-vehicle network, a plurality of electronic control units (ECUs) 21 are connected via a plurality of CAN buses 22, and the monitoring device 100 is connected to the plurality of CAN buses 22. It should be noted that the in-vehicle network need not be limited to the CAN. For example, the in-vehicle network may be a communication network based on Ethernet (registered trademark). As illustrated in FIG. 13, the monitoring device 100 includes a first communication unit 110, a second communication unit 120, a storage unit 130, a temporary storage unit 140, and a control unit 150. The following described each of the structural components of the monitoring device 100.

(First Communication Unit)

The first communication unit 110 obtains over time CAN messages passing through the plurality of CAN buses 22. The CAN message is one example of communication data, and control commands based on the CAN. More specifically, the first communication unit 110 obtains a plurality of communication data items on the in-vehicle network. The CAN messages obtained by the first communication unit 110 are stored in a buffer memory (not illustrated).

(Second Communication Unit)

The second communication unit 120 communicates with the server 30 via a network (e.g., a mobile communication network, the Internet, etc.) which is different from the in-vehicle network. The second communication unit 120 is mounted as, for example, a telematic communication unit (TCU), an in-vehicle infotainment (IVI), etc.

(Storage Unit)

The storage unit 130 is one example of the first storage unit, and stores a full log 131 and a determination rule 132. The storage unit 130 is, for example, mounted using at least one semiconductor memory and/or at least one hard disk drive.

The full log means a log of communication data. Here, the full log is data of a list of CAN messages to which time stamps are attached. A full log 131 stored in the storage unit 130 includes a CAN message determined as being anomalous. The full log 131 may be subjected to data compression, or may be encrypted.

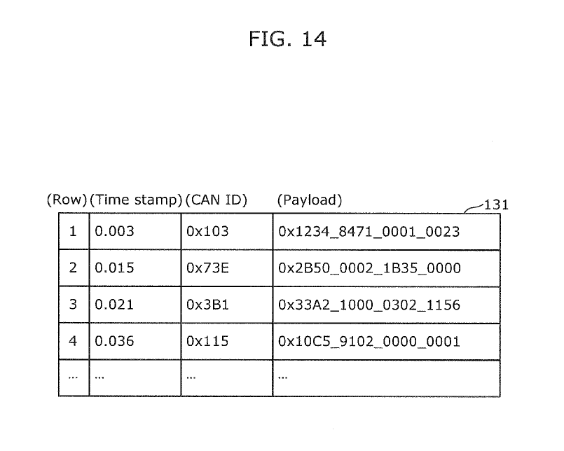

FIG. 14 illustrates one example of the full log 131 according to Embodiment 2. In the full log 131 illustrated in FIG. 14, a time stamp is attached in seconds to a CAN message including a CAN ID and a payload. The CAN ID is an identifier which identifies a message in the CAN. The payload is a data body of the CAN message, and includes a value indicating the amount of control for driving control, such as an acceleration amount.

The determination rule 132 is a rule predetermined for determining an anomaly level of a CAN message. The determination rule 132 is defined by a threshold of a feature value, for example.

Alternatively, the determination rule 132 may be defined by a function of a feature value, for example. The determination rule 132 will be described later with reference to the drawings.

(Temporary Storage Unit)

The temporary storage unit 140 is one example of the second storage unit, and temporarily stores a full log 141. The full log 141 stored in the temporary storage unit 140 includes a CAN message determined as being indeterminable whether being normal or anomalous. The temporary storage unit 140 is, for example, mounted using at least one semiconductor memory and/or at least one hard disk drive. In addition, the storage unit 130 and the temporary storage unit 140 are not necessarily mounted as physically separate recording media. For example, the storage unit 130 and the temporary storage unit 140 may be implemented as two logically separated regions on physically the same recording medium.

(Control Unit)

The control unit 150 is one example of the first control unit, and controls the first communication unit 110, the second communication unit 120, the storage unit 130, and the temporary storage unit 140. The control unit 150 changes at least one of a method of transmitting a full log to the server 30 and a method of storing a full log, according to the anomaly level of a CAN message.

The method of transmitting a full log includes, for example, specifying whether to transmit the full log. In addition, the method of transmitting a full log may include, for example, specifying a timing of transmitting the full log. Furthermore, the method of transmitting a full log may include, for example, specifying a procedure of transmitting the full log.

The method of storing a full log includes, for example, specifying whether to store the full log. In addition, the method of storing a full log may include, for example, a procedure of storing the full log in the storage unit 130.

As illustrated in FIG. 13, the control unit 150 includes an anomaly determination unit 151, a communication control unit 152, and a storage control unit 153. The control unit 150 may be implemented as software using at least one general-purpose processor and a memory, or as hardware using at least one dedicated integrated circuit.

The anomaly determination unit 151 is one example of the first determination unit, and determines an anomaly level of a CAN message from among a plurality of anomaly levels including black that indicates anomalous, white that indicates normal, and gray that indicates indeterminable, based on the determination rule 132. More specifically, the anomaly determination unit 151 extracts a feature value from a CAN message, and determines an anomaly level of the CAN message, using the extracted feature value. The details of the feature value will be described later with reference to the drawings.

The communication control unit 152 is one example of the first communication control unit, and controls the second communication unit 120. The communication control unit 152 transmits the full log to the server 30, according to the method of transmitting that is changed according to the determined anomaly level.

More specifically, the communication control unit 152 transmits the full log to the server 30 when the anomaly level of the CAN message is determined as black. On the other hand, when the anomaly level of the CAN message is determined as white, the communication control unit 152 does not transmit the full log to the server 30, and transmits the feature value of the CAN message to the server 30.

In addition, when the anomaly level of the CAN message is determined as gray, the communication control unit 152 first transmits the feature value of the CAN message to the server 30. Then, when a result of determination indicating that the anomaly level of the CAN message is black is received from the server 30, the communication control unit 152 transmits the full log to the server 30. On the other hand, when a result of determination indicating that the anomaly level of the CAN message is white is received from the server 30, the communication control unit 152 does not transmit the full log to the server 30.

The storage control unit 153 controls the storage unit 130 and the temporary storage unit 140. The storage control unit 153 stores the full log in the storage unit 130 or the temporary storage unit 140, according to the method of storing that is changed according to the determined anomaly level.

More specifically, the storage control unit 153 stores the full log 131 in the storage unit 130 when the anomaly level of the CAN message is determined as black. The storage control unit 153 first stores the full log 141 in the temporary storage unit 140 when the anomaly level of the CAN message is determined as gray. Then, when a result of determination indicating that the anomaly level of the CAN message is black is received from the server 30, the storage control unit 153 transfers the full log 141 stored in the temporary storage unit 140, to the storage unit 130. On the other hand, when a result of determination indicating that the anomaly level of the CAN message is white is received from the server 30, the storage control unit 153 deletes the full log 141 stored in the temporary storage unit 140. It should be noted that, in the deleting of the full log 141, only management information of the full log 141 may be deleted from a management region, or the full log 141 itself may be deleted from an actual data region, in addition to deleting the management information.

[Configuration of Server]

Next, a configuration of the server 30 will be described. The server 30 is installed outside the vehicle 20, and communicates with the monitoring device 100 via a network different from the in-vehicle network. As illustrated in FIG. 13, the server 30 includes a communication unit 31, a storage unit 32, and a control unit 33.

The communication unit 31 is one example of a third communication unit, and communicates with the monitoring device 100 mounted on the vehicle 20.

The storage unit 32 is one example of the third storage unit, and stores a learning model 322 for determining an anomaly level of a CAN message. Furthermore, the storage unit 32 stores a full log 321 received from the monitoring device 100. The storage unit 32 is, for example, mounted using at least one semiconductor memory and/or at least one hard disk drive.

The learning model 322 is a mathematical model for determining whether a CAN message is anomalous (black) or normal (white), based on a feature value of the CAN message. Examples of the learning model 322 include, for example, a learning model used in anomaly detecting techniques such as the local outlier factor (LOF) and the support vector machine (SVM), but not strictly limited. The control unit 33 is one example of the second control unit, and controls the communication unit 31 and the storage unit 32. The control unit 33 may be implemented as software using at least one general-purpose processor and a memory, or as hardware using at least one dedicated integrated circuit. As illustrated in FIG. 13, the control unit 33 includes an anomaly determination unit 331, a communication control unit 332, and a model updating unit 333.

The anomaly determination unit 331 is one example of the second determination unit. When the communication unit 31 receives, from the monitoring device 100, a feature value of a CAN message whose anomaly level is determined as gray by the monitoring device 100, the anomaly determination unit 331 determines the anomaly level of the CAN message as black or white, using the received feature value of the CAN message and the learning model 322 stored in the storage unit 32. Examples of the method of determining an anomaly level include, for example, the anomaly determination method used in the anomaly detecting techniques such as above-described LOF and the SVM, but not strictly limited.

The communication control unit 332 is one example of the second communication control unit, and transmits a result of determination of the anomaly level performed in the server 30, to the monitoring device 100. More specifically, the communication control unit 332 receives a full log from the monitoring device 100 when the anomaly level of the CAN message is determined as black.

(Operation of Monitoring System)

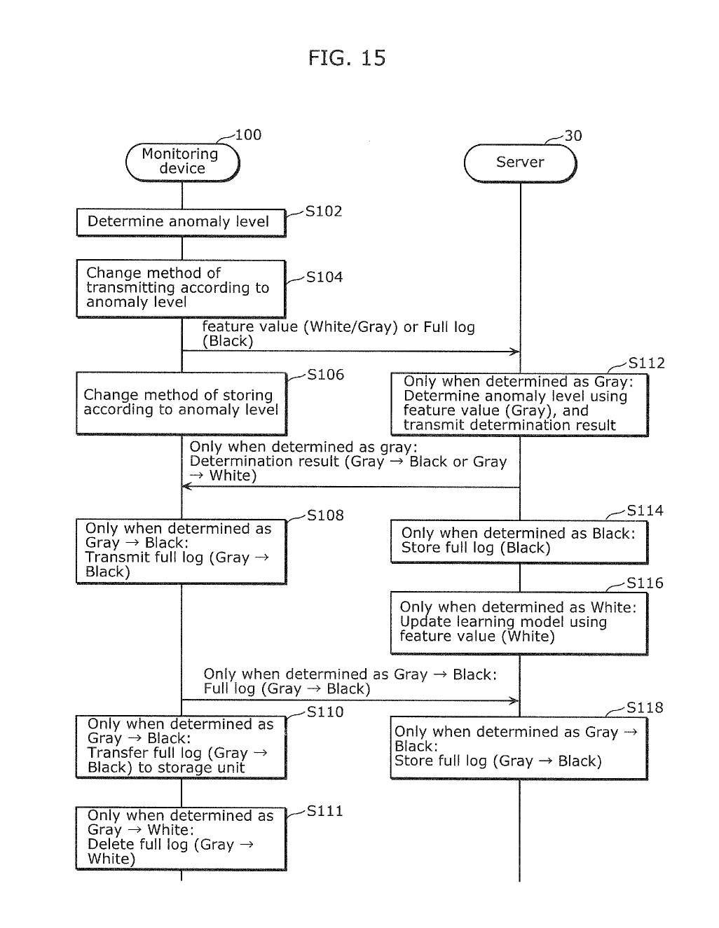

Next, an operation of the monitoring system x10 having the above-described configuration will be described in detail with reference to FIG. 15. FIG. 15 is a sequence diagram of the monitoring system x10 according to Embodiment 2. It should be noted that, in the following description and the diagrams, a color such as white, black, and gray indicated in a parentheses following data indicates a result of determination of an anomaly level. For example, the expression (black) indicates that the anomaly level is determined as black by the monitoring device 100 or the server 30. In addition, the expression (gray→black) indicates that the anomaly level is determined as gray by the monitoring device 100, and then determined as black by the server 30.

First, in the monitoring device 100, the anomaly determination unit 151 determines an anomaly level of a CAN message (S102). Then, the communication control unit 152 of the monitoring device 100 changes a method of transmitting a full log according to the anomaly level (S104). By doing so, feature value data (white/gray) or a full log (black) is transmitted to the server 30. Furthermore, the storage control unit 153 changes a method of storing the full log according to the anomaly level (S106).

In the server 30, when a feature value (gray) of a CAN message whose anomaly level is determined as gray is received, the anomaly determination unit 331 determines whether the anomaly level of the CAN message is black or white, using the feature value (gray) and the learning model 322 (S112). Then, a result of the determination is transmitted to the monitoring device 100. On the other hand, when a full log (black) of the CAN message whose anomaly level is determined as black is received, the control unit 33 stores the full log in the storage unit 32 (S114). When a feature value (white) of the CAN message whose anomaly level is determined as white is received, the control unit 33 updates the learning model 322 using the feature value (white) as training data (S116).

When the monitoring device 100 determines the anomaly level as gray in the above-described Step S102, the monitoring device 100 waits and receives a result of determination transmitted from the server 30. When the monitoring device 100 receives from the server 30 a result of determination indicating that the anomaly level of the CAN message is black, the communication control unit 152 transmits to the server 30 the full log (gray→black) of the CAN message (S108). In the server 30 by which the transmitted full log (gray→black) is received, the control unit 33 stores the full log in the storage unit 32 (S118). In the monitoring device 100, the storage control unit 153 transfers the full log (gray→black) of the CAN message from the temporary storage unit 140 to the storage unit 130 (S110).

In contrast, when the monitoring device 100 receives from the server 30 a result of determination indicating that the anomaly level of the CAN message is white, the control unit 33 of the monitoring device 100 deletes the full log (gray→white) of the CAN message stored in the temporary storage unit 140 (S111).

(Operation of Monitoring Device)

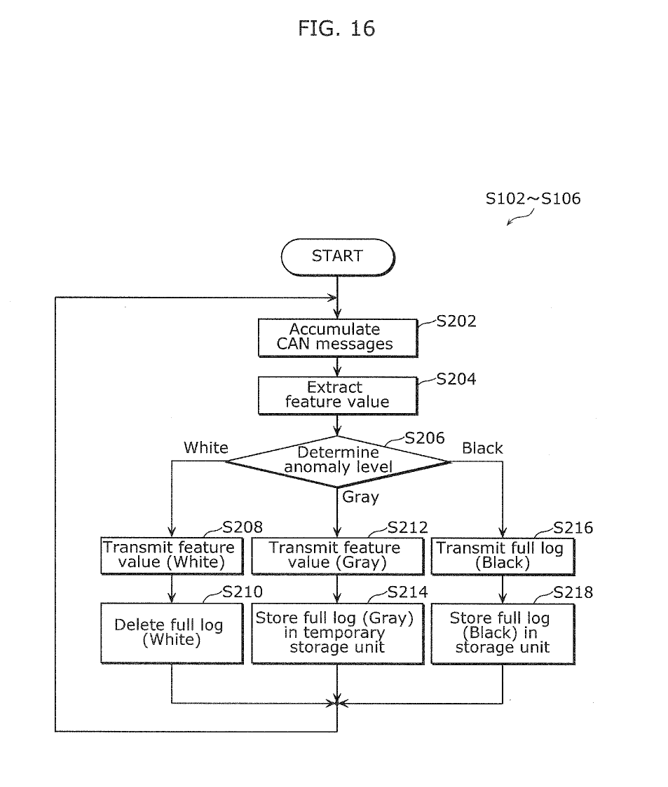

The following describes in detail an operation of the monitoring device 100 in the monitoring system x10 as described above, with reference to FIG. 16 to FIG. 24. FIG. 16 is a flowchart which illustrates a first operation of the monitoring device 100 according to Embodiment 2. More specifically, FIG. 16 illustrates the details of Step S102 to Step S106 of FIG. 15.

First, the first communication unit 110 obtains CAN messages on the in-vehicle network over time, and accumulates the obtained CAN messages in a buffer memory (S202). The anomaly determination unit 151 extracts a feature value from a plurality of CAN messages accumulated in the buffer memory (S204).

As the feature value, a value included in a payload of the CAN messages can be used. In this case, the anomaly determination unit 151 may extract, as a first feature value, a value included in at least one CAN message having a predetermined CAN ID, among the plurality of CAN messages.

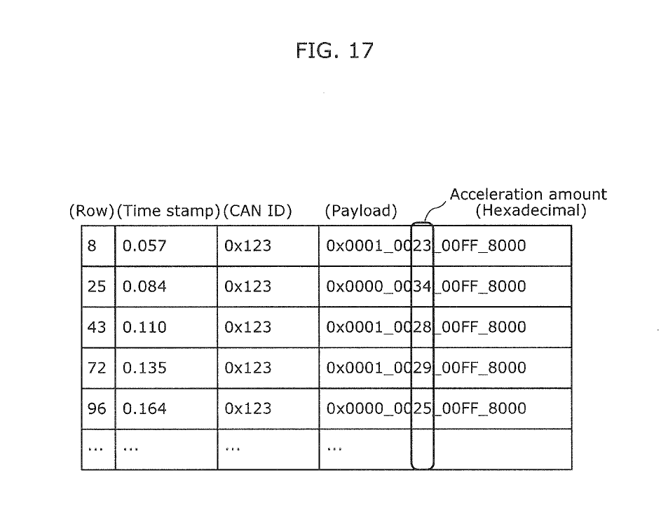

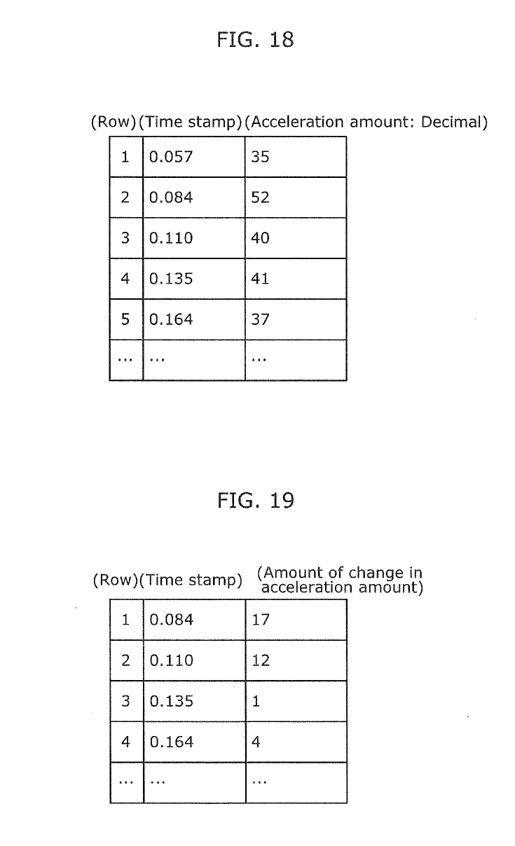

For example, the case where an acceleration amount in the CAN message is extracted as the first feature value will be described with reference to FIG. 17 and FIG. 18. FIG. 17 indicates a location of an acceleration amount in a CAN message according to Embodiment 2. FIG. 18 indicates one example of the first feature value according to Embodiment 2. More specifically, FIG. 18 indicates the first feature value extracted from the CAN message illustrated in FIG. 17. The acceleration amounts displayed in decimal in FIG. 18 are extracted as the first feature values, based on the acceleration amounts displayed in hexadecimal and included in the CAN messages each having a CAN ID of “0x123” in FIG. 17.

In addition, as a feature value, an amount of change of the first feature value can also be used. In this case, the anomaly determination unit 151 may extract, as a second feature value, an amount of change in a value included in each of at least two CAN messages having a predetermined CAN ID, among the plurality of CAN messages. FIG. 19 indicates one example of the second feature value according to Embodiment 2. More specifically, FIG. 19 indicates an amount of change in the first feature values in FIG. 18. Here, the amount of change is an absolute value of a difference value between a value included in a CAN message and a value included in a CAN message immediately preceding the CAN message.

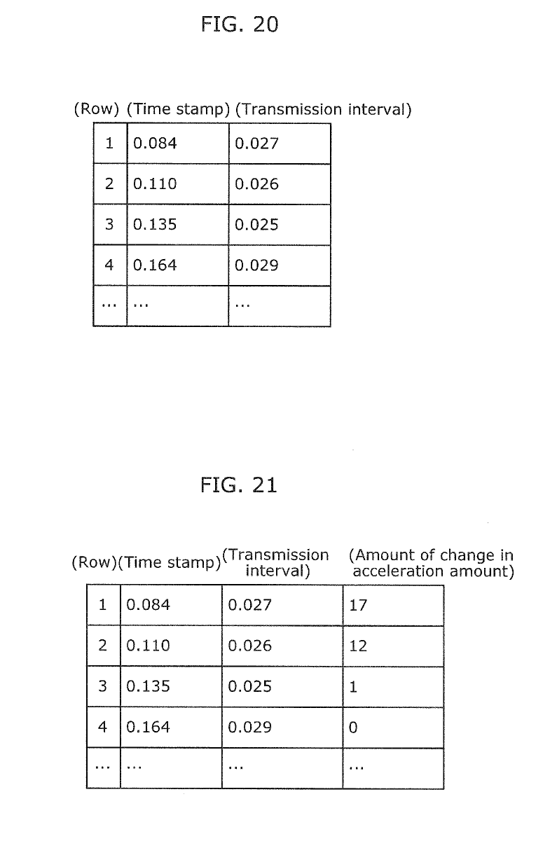

In addition, as a feature value, a transmission interval of CAN messages can also be used. In this case, the anomaly determination unit 151 may extract, as a third feature value, a time difference between transmission time points of at least two CAN messages each having a predetermined CAN ID among the plurality of CAN messages. FIG. 20 illustrates one example of the third feature value according to Embodiment 2. More specifically, FIG. 20 illustrates the third feature value extracted from the CAN messages illustrated in FIG. 17.

It should be noted that, as a feature value, an arbitrary combination of the first feature value, the second feature value, and the third feature value may be used. FIG. 21 illustrates one example of a combination of a plurality of feature values according to Embodiment 2. More specifically, FIG. 21 illustrates a combination of the second feature value indicated in FIG. 19 and the third feature value indicated in FIG. 20.

The anomaly determination unit 151 determines an anomaly level of a plurality of CAN messages on the basis of a predetermined determination rule, using a feature value extracted in the above-described manner (S206). For example, when an anomaly level of each of a plurality of CAN messages is determined, and the plurality of CAN messages include even one CAN message whose anomaly level is black, the anomaly determination unit 151 determines the anomaly level of the plurality of CAN messages as black. In addition, for example, when a plurality of CAN messages include a CAN message whose anomaly level is gray and no CAN message whose anomaly level is black, the anomaly determination unit 151 determines the anomaly levels of the plurality of CAN messages as gray. In addition, for example, when anomaly levels of all of a plurality of CAN messages are determined as white, the anomaly determination unit 151 determines the anomaly levels of the plurality of CAN messages as white.

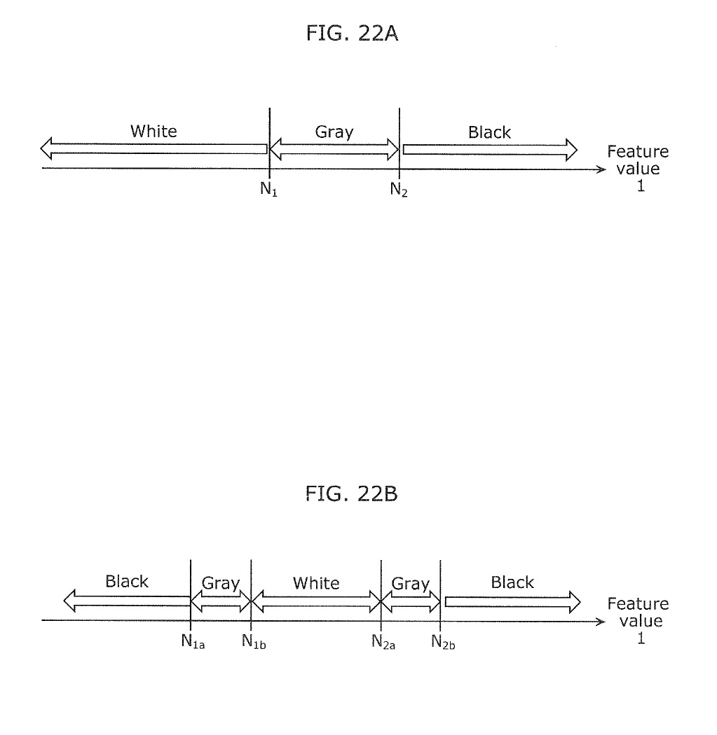

At this time, in determining an anomaly level of each of the CAN messages, one feature value extracted from each of the CAN messages may be compared to a threshold. FIG. 22A and FIG. 22B are each a conceptual diagram which illustrates one example of the anomaly level determination using one feature value according to Embodiment 2.

In the example illustrated in FIG. 22A, an anomaly level is determined as white when a feature value 1 is less than a threshold N₁. In addition, the anomaly level is determined as black when the feature value 1 is greater than a threshold N₂. In addition, the anomaly level is determined as gray when the feature value 1 is between the threshold N₁ and the threshold N₂.

In the example illustrated in FIG. 22B, an anomaly level is determined as black when the feature value 1 is less than a threshold N₁ₐ or greater than a threshold N_{2b}. The anomaly level is determined as white when the feature value 1 is between the threshold N_{1b} and the threshold N₂ₐ. The anomaly level is determined as gray in the other cases.

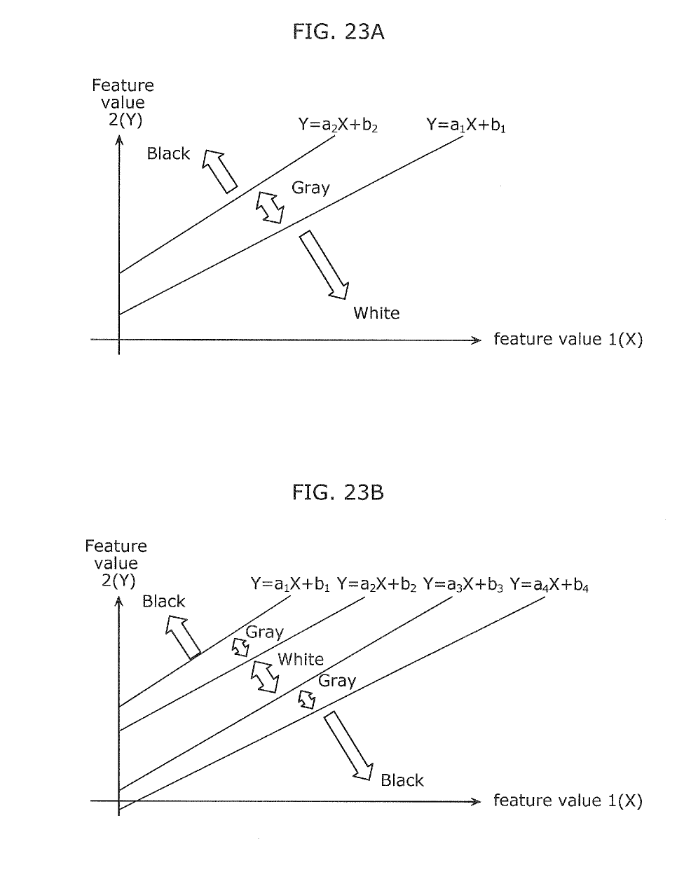

In addition, for example, in determining an anomaly level of each of the CAN messages, one of two feature values extracted from each of the CAN messages may be compared to a function of the other, thereby determining the anomaly level of each of the CAN messages. FIG. 23A and FIG. 23B are each a conceptual diagram which illustrates one example of the anomaly level determination using two feature values according to Embodiment 2.

In the example illustrated in FIG. 23A, an anomaly level is determined as white when a feature value 2(Y) is less than a function Y=a₁X+b₁ of a feature value 1(X). The anomaly level is determined as black when the feature value 2(Y) is greater than a function Y=a₂X+b₂ of the feature value 1(X). The anomaly level is determined as gray in the other cases.

In the example illustrated in FIG. 23B, an anomaly level is determined as black when a feature value 2(Y) is less than a function Y=a₁X+b₁ of a feature value 1(X), or the feature value 2(Y) is less than a function Y=a₄X+b₄ of a feature value 1(X). In addition, the anomaly level is determined as white when the feature value 2(Y) is between a function Ya₂X+b₂ of the feature value 1(X) and a function Ya₃X+b₃ of the feature value 1(X). The anomaly level is determined as gray in the other cases.

It should be noted that FIG. 22A to FIG. 23B each show an example of the determination rule for each CAN message. However, the determination rule need not be limited to these examples. For example, in the example illustrated in FIG. 22A, the determination as white or black may be inverse. In other words, an anomaly level may be determined as black when the feature value 1 is less than the threshold N₁, and the anomaly level may be determined as white when the feature value 1 is greater than a threshold N₂.

Returning to FIG. 16, the operation illustrated by the flowchart will be further described. When the anomaly level of the plurality of CAN messages is determined as white (White in S206), the communication control unit 152 transmits a feature value (White) of the plurality of CAN messages to the server 30 (S208). Then, the full log of the plurality of CAN messages is deleted (S210). In other words, the full log is not stored in the storage unit 130 or the temporary storage unit 140.

When the anomaly level of the plurality of CAN messages is determined as gray (Gray in S206), the communication control unit 152 transmits a feature value (Gray) of the plurality of CAN messages to the server 30 (S212). In addition, the storage control unit 153 stores a full log (Gray) of the plurality of CAN messages in the temporary storage unit 140 (S214).

When the anomaly level of the plurality of CAN messages is determined as black (Black in S206), the communication control unit 152 transmits a full log (Black) of the plurality of CAN messages to the server 30 (S216). In addition, the storage control unit 153 stores the full log (Black) of the plurality of CAN messages in the storage unit 130 (S218).

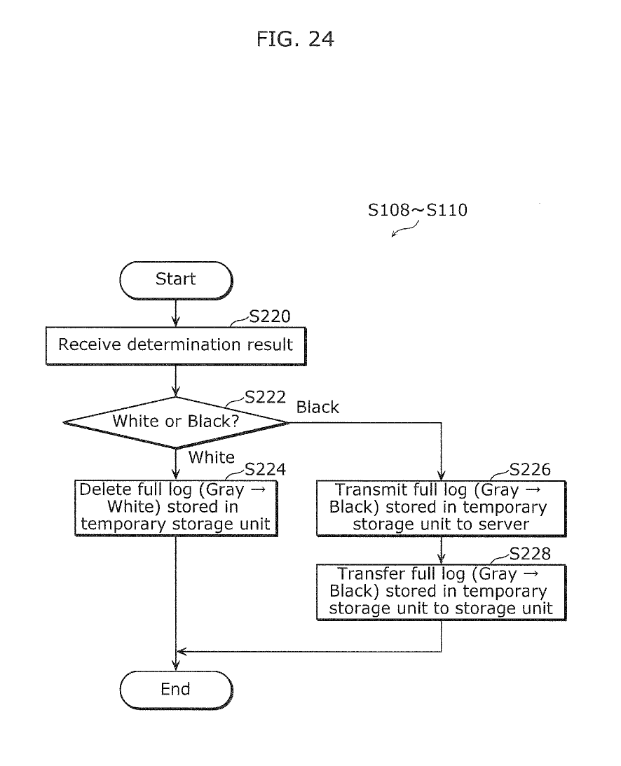

FIG. 24 is a flowchart which illustrates a second operation of the monitoring device 100 according to Embodiment 2. More specifically, FIG. 24 illustrates the details of Step S108 to Step S111 of FIG. 15.

The monitoring device 100 receives a result of determination from the server 30 (S220). The result of determination is a result of determining, by the server 30, whether the plurality of CAN messages whose anomaly level has been determined as gray by the monitoring device 100 is black or white.

Here, when the received result of determination is white (White in S222), the storage control unit 153 deletes the full log stored in the temporary storage (S224). On the other hand, when the received result of determination is black (Black in S222), the communication control unit 152 transmits the full log stored in the temporary storage unit 140 to the server 30 (S226). Furthermore, the communication control unit 152 transfers the full log stored in the temporary storage unit 140 to the storage unit 130 (S228).

(Operation of Server)

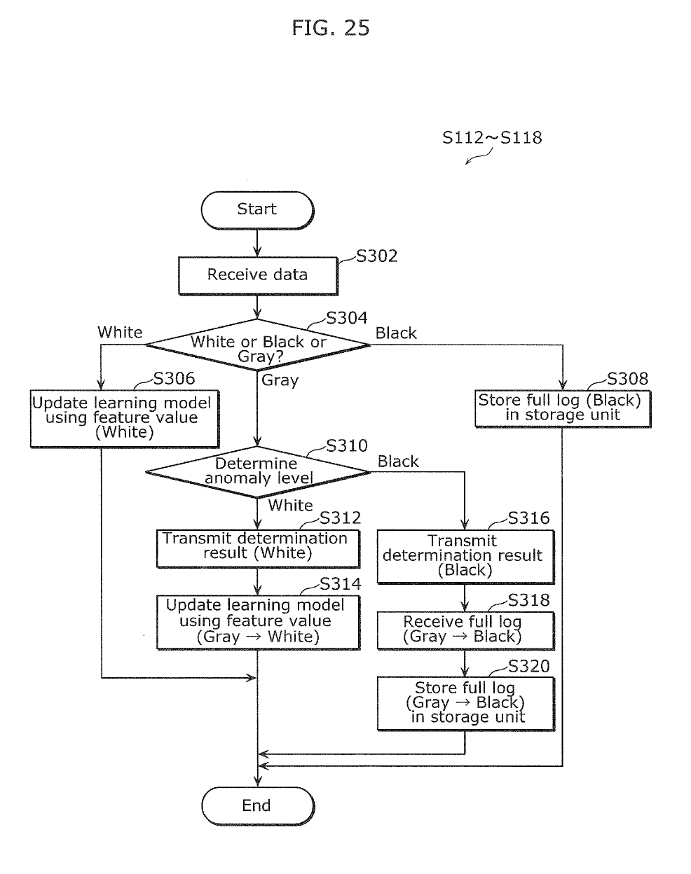

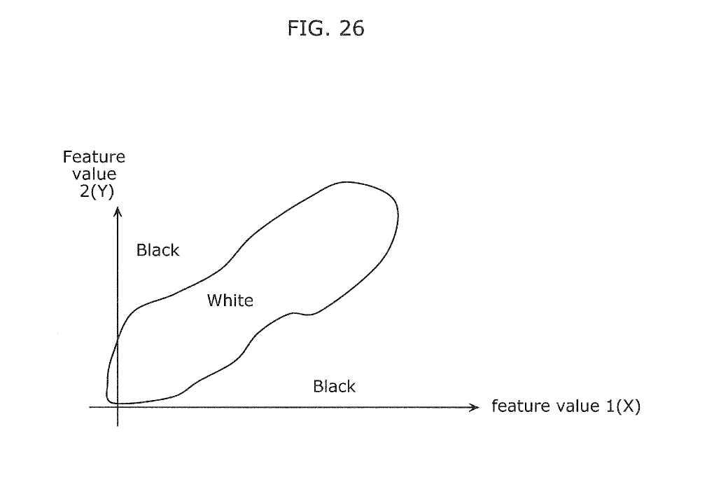

Next, an operation of the server 30 will be described in detail with reference to FIG. 25 and FIG. 26. FIG. 25 illustrates a flowchart showing the operation of the server 30 according to Embodiment 2. More specifically, FIG. 25 illustrates the details of Step S112 to Step S118 of FIG. 15.

First, the communication unit 31 of the server 30 receives data from the monitoring device 100 (S302). When the received data is a feature value of a CAN message whose anomaly level is determined as white by the monitoring device 100 (White in S304), the model updating unit 333 updates the learning model 322 using the received feature value (white) (S306). In other words, the model updating unit 333 performs supervised learning using the received feature value (White).

When the received data is a full log of a CAN message whose anomaly level is determined as black by the monitoring device 100 (Black in S304), the control unit 33 stores the full log (black) in the storage unit 32 (S308).

When the received data is a feature value of a CAN message whose anomaly level is determined as gray by the monitoring device 100 (Gray in S304), the anomaly determination unit 331 determines the anomaly level of the CAN message on the basis of the received feature value, using the learning model 322 (S310). In other words, the anomaly determination unit 331 determines the anomaly level of a CAN message as black or white.

FIG. 26 is a conceptual diagram which illustrates one example of the anomaly level determination using a learning model according to Embodiment 2. In the example illustrated in FIG. 26, white and black regions are defined for two feature values, and a gray region is not present.

Here, when the anomaly level is determined as white (White in S310), the communication control unit 332 transmits a result of determination (White) indicating white to the monitoring device 100 (S312). In addition, the model updating unit 333 updates the learning model 322 using a feature value (Gray→White) (S314). On the other hand, when the anomaly level is determined as black (Black in S310), the communication control unit 332 transmits a result of determination (Black) indicating black to the monitoring device 100 (S316). Subsequently, the communication unit 31 receives a full log (Gray→Black) from the monitoring device 100 (S318), and the control unit 33 stores the received full log (Gray→Black) in the storage unit 32 (S320).

### Advantageous Effects, Etc.

As described above, with the monitoring device 100 according to the present embodiment, it is possible to determine, by the monitoring device 100 mounted in the vehicle 20, an anomaly level of a CAN message from among a plurality of anomaly levels including black which indicates anomalous, white which indicates normal, and gray which indicates indeterminable. Accordingly, in the case where the monitoring device 100 cannot determine the anomaly level as black or white with accuracy, it is not necessarily required to perform determination on black or white, and thus it is possible to reduce erroneous determination on an anomaly level by the monitoring device, and to improve accuracy in determining the anomaly level.

In addition, since it is possible to change at least one of the method of transmitting a full log of a CAN message to the server 30 and the method of storing the full log of the CAN message, according to the determined anomaly level of the CAN message, it is also possible to reduce the amount of communication and/or the capacity of the storage device.

In addition, with the monitoring device 100 according to the present embodiment, various feature values can be used for determination on an anomaly level, and thus it is possible to improve accuracy in determining the anomaly level.

In addition, with the monitoring device 100 according to the present embodiment, when the anomaly level of a CAN message is determined as gray, it is possible to transmit a feature value of the CAN message to the server 30. Subsequently, when a result of determination which indicates that the anomaly level of the CAN message is black is received from the server 30, it is possible to transmit a full log of the CAN message to the server 30. Accordingly, it is possible to transmit, as necessary, a full log of a CAN message whose anomaly level cannot be determined by the monitoring device, based on a result of determination performed by the server 30. It is therefore possible to reduce the amount of communication.

In addition, with the monitoring device 100 according to the present embodiment, when the anomaly level of a CAN message is determined as gray, it is possible to transmit a feature value of the CAN message to the server 30. Subsequently, when a result of determination which indicates that the anomaly level of the CAN message is black is received from the server 30, it is possible to transmit a full log of the CAN message to the server 30. Accordingly, it is possible to transmit, as necessary, a full log of a CAN message whose anomaly level cannot be determined by the monitoring device 100, based on a result of determination performed by the server 30. It is therefore possible to reduce the amount of communication.

In addition, with the monitoring device 100 according to the present embodiment, it is possible to temporarily store a full log of a CAN message in the temporary storage unit 140 when the anomaly level of the CAN message is determined as gray, and transfer the full log of the CAN message stored in the temporary storage unit 140 to the storage unit 130 when a result of determination which indicates that the anomaly level of the CAN message is black is received from the server 30. Accordingly, it is possible to store in the storage unit 130, as necessary, a full log of a CAN message whose anomaly level cannot be determined by the monitoring device 100, based on a result of determination performed by the server 30. It is therefore possible to reduce the capacity of the storage device.

In addition, with the monitoring system x10 according to the present embodiment, the server 30 only need to determine, as black or white, the anomaly level of a CAN message whose anomaly level is determined as gray by the monitoring device 100. It is therefore possible to reduce the load of determining the anomaly level by the server 30.

In addition, with the monitoring system x10 according to the present embodiment, the server 30 is capable of determining an anomaly level of a CAN message, using the learning model 322, and thus it is possible to determine the anomaly level with higher accuracy.

In addition, with the monitoring system x10 according to the present embodiment, the server 30 is capable of updating the learning model 322, using a feature value of a CAN message whose anomaly level is determined a white. Accordingly, it is possible to establish the learning model 322 having a higher determination accuracy, and thus to flexibly address changes in an environment.

### Variation

Next, a variation of the above-described Embodiment 2 will be described.

Although the feature value used in determining an anomaly level by the monitoring device 100 matches the feature value used in determining an anomaly level by the server 30 in the above-described Embodiment 2, the monitoring device 100 and the server 30 may use feature values different from each other. In this case, when the anomaly level of a CAN message is determined as gray, the communication control unit 332 of the monitoring device 100 may transmit, to the server 30, an output value of each sensor (e.g., a global positioning system (GPS) sensor, an in-vehicle camera, etc.), in addition to the feature value of the CAN message. In addition, the server 30 may extract a feature value from an output value of each sensor.

In addition, although a feature value is transmitted without transmitting a full log when the anomaly level of a CAN message is determined as gray in the above-described Embodiment 2, both of the feature value and the full log, or only the full log may be transmitted. When only the full log is transmitted, the server 30 may extract, from the full log, a feature value to be used in the determination of the anomaly level. When the accuracy of the determination of the anomaly level performed by the monitoring device 100 is high, the determination does not frequently result in gray. Accordingly, in such a case, even when both of the feature value and the full log are, or only the full log is transmitted, harmful effects on the amount of communication will be small.

In addition, although a full log is transmitted when the anomaly level of a CAN message is determined as black in the above-described Embodiment 2, only the result of determination as black may simply be notified to the server 30. In this case, a full log may be transmitted from the monitoring device 100 to the server 30 in response to a request from the server 30.

In addition, although the full log stored in the temporary storage unit 140 is deleted from the temporary storage unit 140 when a result of determination is received from the server 30 in the above-described Embodiment 2, the present disclosure is not limited to this example. For example, the full log may be deleted from the temporary storage unit 140 when another predetermined condition is satisfied. For example, the full log may be deleted from the temporary storage unit 140 on the basis of a period of time elapsed after the full log is stored in the temporary storage unit 140, an explicit instruction of deletion by a user, an available capacity of the temporary storage unit 140, or the like.

In addition, although deleting of the full log stored in the storage unit 130 is not particularly described in the above-described Embodiment 2, the full log may be deleted from the storage unit 130 when a predetermined condition is satisfied. For example, the full log may be deleted from the storage unit 130 when an instruction of deletion is received from the server 30. In this case, the server 30 may transmit an instruction of deletion to the monitoring device 100, after the server 30 stored the full log in the storage unit 32. With this, it is possible to reduce wasteful use of resources of storing the full log in both of the server 30 and the monitoring device 100. Alternatively, the full log may be deleted from the storage unit 130 on the basis of a period of time elapsed after the full log is stored in the storage unit 130, an explicit instruction of deletion by a user, an available capacity of the storage unit 130, or the like.

In addition, although an anomaly level is determined after a plurality of CAN messages are accumulated in the above-described Embodiment 2, an anomaly level of a CAN message may be determined every time the CAN message is obtained. Furthermore, it is not necessary to specifically limit the amount of CAN messages whose anomaly levels are to be determined. Anomaly levels of CAN messages accumulated at predetermined time intervals may be determined.

In addition, although the case where one or two types of feature value is used in determining of the anomaly level is described in the above-described Embodiment 2, three or more types of feature value may be used. In this case, an anomaly level is determined in multiple dimensions including at least three dimensions.

In addition, although a feature value is extracted from a CAN message having one particular CAN ID in the above-described Embodiment 2, the present disclosure is not limited to this example. A feature value may be extracted, for each of a plurality of CAN IDs, in the same manner as the above-described Embodiment 2.

In addition, although the first to third feature values are described as feature values in the above-described Embodiment 2, the feature value is not limited these examples. For example, an amount of statistics (e.g., an average value, a variance value, etc.) of each of the first to third feature values in the above-described Embodiment 2 may be used as a feature value.

### Embodiment 3

Next, Embodiment 3 will be described. The present embodiment differs from the above-described Embodiment 2 in that, for each result of anomaly determination, a log of accumulated communication data is transmitted from a monitoring device to a server according to a data amount of the log. The following describes a monitoring system according to the present embodiment, focusing on a difference from the above-described Embodiment 2.

(Configuration of Monitoring System)

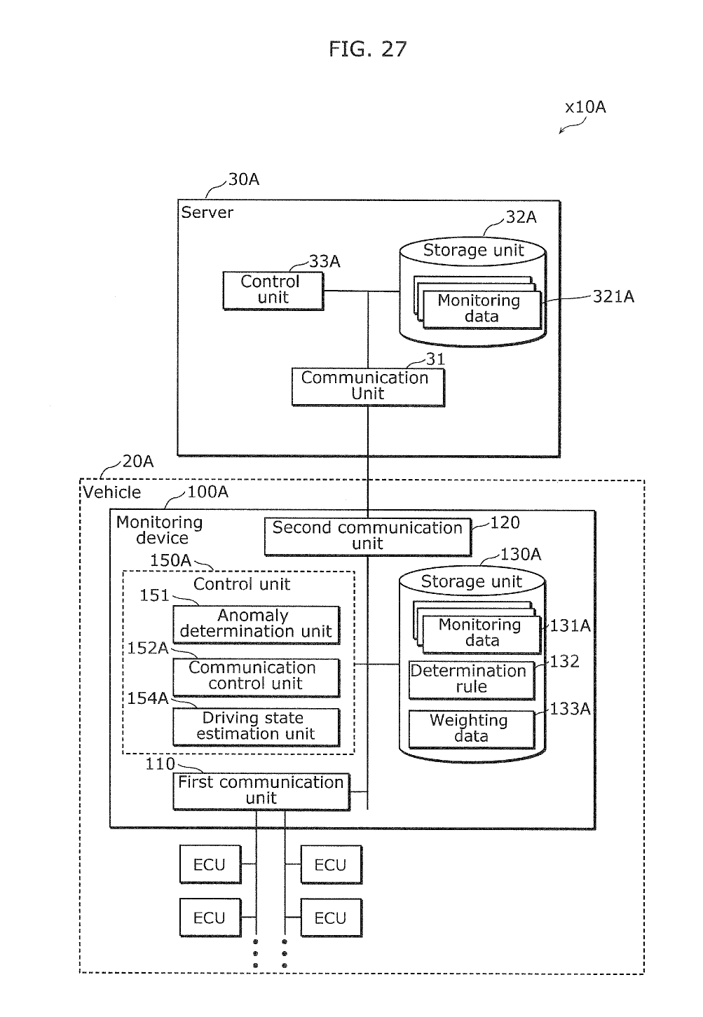

A configuration of a monitoring system according to Embodiment 3 will be described in detail with reference to FIG. 27. FIG. 27 is a block diagram which illustrates a functional configuration of a monitoring system x10A according to Embodiment 3.

The monitoring system x10A according to the present embodiment includes a monitoring device 100A mounted on a vehicle 20A and a server 30A capable of communicating with the monitoring device 100A.

[Configuration of Monitoring Device]

The monitoring device 100A is mounted on the vehicle 20A as with Embodiment 2, and monitors an in-vehicle network. The monitoring device 100A includes a first communication unit 110, a second communication unit 120, a storage unit 130A, and a control unit 150A. The following described each of the structural components of the monitoring device 100A, focusing on a difference from Embodiment 2.

(Storage Unit)

The storage unit 130A is one example of the first storage unit, and stores monitoring data 131A, determination rule 132, and weighting data 133A. The storage unit 130A is, for example, mounted using at least one semiconductor memory and/or at least one hard disk drive.

The monitoring data 131A is a log of a CAN message on the in-vehicle network, which is sorted by anomaly levels. FIG. 28 illustrates one example of the monitoring data 131A according to Embodiment 3. More specifically, FIG. 28 illustrates, in (a), (b), and (c), items of monitoring data of CAN messages whose anomaly levels are determined as white, black, and gray, respectively.

In FIG. 28, the monitoring data 131A includes a data length code (DLC), a bus (Bus), a level (Level), an error code (ErrorCode), and vehicle information (CarInfo), in addition to a time stamp (TimeStamp), a CAN ID, and data (Data) corresponding to the payload of Embodiment 2.

Here, the data length code indicates the number of bytes of data. The bus is information for separately identifying a plurality of CAN buses 22. The level indicates an anomaly level. In the level, “W” denotes white, “B” denotes black, and “G” denotes gray. The error code is information for identifying the details of an error. The vehicle information is information for identifying a type of a vehicle.

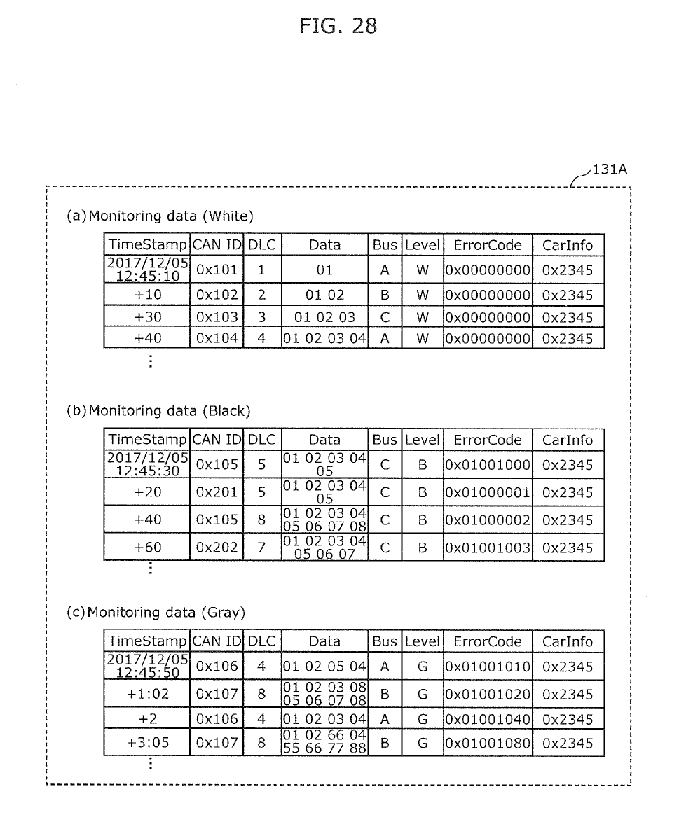

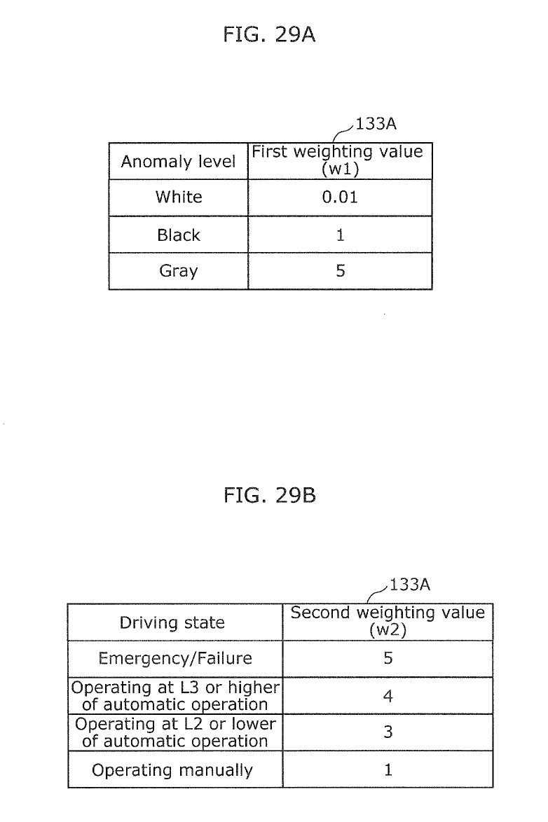

The weighting data 133A is data which indicates a weight used in determination of an anomaly level. FIG. 29A and FIG. 29B each indicate one example of weighting data 133A according to Embodiment 3. More specifically, FIG. 29A illustrates a first weight table in which a plurality of anomaly levels are associated with a plurality of first weight values (w1). The first weight value indicates the degree of importance of monitoring. The degree of importance increases as a value is greater. FIG. 29B illustrates a second weight table in which a plurality of driving states are associated with a plurality of second weight values (w2). The second weight value indicates the degree of importance of communication. The degree of importance increases as a value is greater.

(Control Unit)

The control unit 150A is one example of the first control unit, and controls the first communication unit 110, the second communication unit 120, and the storage unit 130A. The control unit 150A changes a method of transmitting monitoring data to the server 30A, according to an anomaly level of a CAN message. According to the present embodiment, the method of transmitting monitoring data is changed by changing a timing of transmission for each of the anomaly levels.

As illustrated in FIG. 27, the control unit 150A includes an anomaly determination unit 151, a communication control unit 152A, and a driving state estimation unit 154A. The control unit 150A may be implemented as software using at least one general-purpose processor and a memory, or as hardware using at least one dedicated integrated circuit.

The communication control unit 152A is one example of the first communication control unit, and controls the second communication unit 120. More specifically, the communication control unit 152A obtains, for each of the anomaly levels, a data amount of the monitoring data 131A stored in the storage unit 130A. The data amount is defined, for example, by the number of records in the table illustrated in FIG. 28. The communication control unit 152A transmits, for each of the anomaly levels, monitoring data to the server 30A, according to the obtained data amount.

More specifically, the communication control unit 152A first weights a data amount, for each of the anomaly levels, using a first weighting value corresponding to the anomaly level and a second weight value corresponding to the driving state. The weighted data amount Dw is represented by Expression (1) indicated below.

Dw=w1×w2×D (1)

Here, w1 denotes the first weight value, and w2 denotes the second weight value. D denotes the data amount of monitoring data for each of the anomaly levels, which is not yet weighted. The communication control unit 152A transmits, for each of the anomaly levels, monitoring data to the server 30A, when the weighted data amount is greater than a predetermined threshold. According to the present embodiment, the same threshold is used as the predetermined threshold in the plurality of anomaly levels. In other words, the predetermined threshold is common among the plurality of anomaly levels.

For example, suppose that the data amounts of monitoring data of white, black, and gray are 1000, 20, and 6, respectively, and the vehicle 20A is driving at level 3 of the automatic operation. In this case, when the first weight value and the second weight value illustrated in FIG. 29A and FIG. 29B are used, the weighted data amounts are, respectively, 40 (=0.01×4×1000), 80 (=1×4×20), and 120 (=5×4×6). Here, when 100 is applied as the threshold, only the monitoring data of gray whose weighted data amount is 120 is transmitted to the server 30A.

The driving state estimation unit 154A estimates a driving state of the vehicle 20A. For example, the driving state estimation unit 154A estimates a driving state on the basis of a CAN message on the in-vehicle network. More specifically, the driving state estimation unit 154A estimates, for example, a driving state on the basis of data of a CAN message having a specific CAN ID.

The driving state means a state of a vehicle which is being driven. According to the present embodiment, the driving state is mainly defined by a level of the automatic operation. For example, in FIG. 29B, the driving state is sorted by: manually operating (i.e., driving at level 0 of the automatic operation); operating at automatic operation L2 or lower (i.e., driving at level 1 or 2 of the automatic operation); operating at automatic operation L3 or higher (i.e., driving at level 3, 4, or 5 of the automatic operation); and emergency/failure.

(Configuration of Server)

Next, a configuration of the server 30A will be described. The server 30A is installed outside the vehicle 20A, and communicates with the monitoring device 100A via a network different from the in-vehicle network. As illustrated in FIG. 27, the server 30A includes a communication unit 31, a storage unit 32A, and a control unit 33A.

The storage unit 32A stores the monitoring data 321A received from the monitoring device 100A. The storage unit 32A is, for example, mounted using at least one semiconductor memory and/or at least one hard disk drive.

The control unit 33A controls the communication unit 31 and the storage unit 32A. The control unit 33A may be implemented as software using at least one general-purpose processor and a memory, or as hardware using at least one dedicated integrated circuit. The control unit 33A stores, in the storage unit 32A, the monitoring data 321A received from the monitoring device 100A.

(Operation of Monitoring Device)

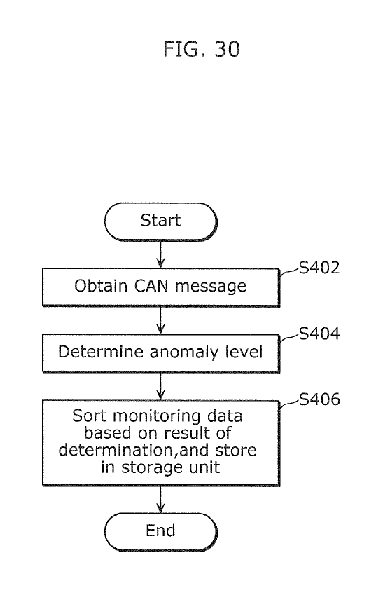

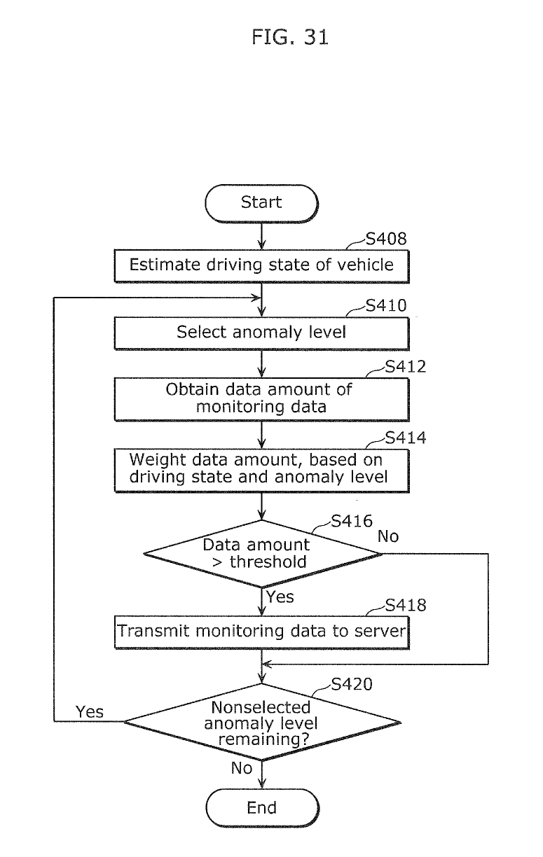

Next, an operation of the monitoring device 100A having the above-described configuration will be described in detail with reference to FIG. 30 and FIG. 31. FIG. 30 is a flowchart which illustrates a first operation of the monitoring device 100A according to Embodiment 3. FIG. 31 is a flowchart which illustrates a second operation of the monitoring device 100A according to Embodiment 3.

As illustrated in FIG. 30, the first communication unit 110 first obtains a CAN message on the in-vehicle network (S402). The anomaly determination unit 151 determines an anomaly level of the CAN message from among a plurality of anomaly levels including black, white, and gray (S404).

The control unit 150A sorts the CAN message based on a result of determination performed by the anomaly determination unit 151, and stores, in the storage unit 130A, the CAN message as the monitoring data 131A (S406). The above-described first operation is executed every time communication traffic of a CAN message is generated on the in-vehicle network. In this manner, for example, the monitoring data 131A illustrated in FIG. 28 is stored in the storage unit 130A.

In a state in which the monitoring data 131A is stored in the storage unit 130A as described above, the driving state estimation unit 154A estimates a driving state of the vehicle 20A as illustrated in FIG. 31 (S408). Here, in order to perform the processing for each of the anomaly levels, the communication control unit 152A selects a nonselected anomaly level (S410). The communication control unit 152A obtains a data amount of the monitoring data 131A of the selected anomaly level (S412).

The communication control unit 152A weights the obtained data amount, based on the estimated driving state and the selected anomaly level (S414). More specifically, the communication control unit 152A obtains a first weight value corresponding to the selected anomaly level and a second weight value corresponding to the estimated driving state, by referring to the weighting data 133A. Then, the communication control unit 152A calculates weighted data amount, by applying the obtained first weight value and second weight value to the obtained data amount.

The communication control unit 152A compares the weighted data amount with a predetermined threshold (S416). When the weighted data amount is greater than the predetermined threshold (Yes in S416), the communication control unit 152A transmits the monitoring data 131A of the selected anomaly level to the server 30A (S418). On the other hand, when the weighted data amount is less than or equal to the predetermined threshold (No in S416), the communication control unit 152A skips transmitting of the monitoring data 131A of the selected anomaly level.

The communication control unit 152A determines whether there is a nonselected anomaly level among the plurality of anomaly levels (S420). Here, when the communication control unit 152A determines that there is a nonselected anomaly level (Yes in S420), the processing returns to the selecting of an anomaly level (S410). On the other hand, when the communication control unit 152A determines that all of the anomaly levels have already been selected (No in S420), the processing is finished.

It should be noted that the monitoring device 100A repeatedly performs the second operation. More specifically, upon finishing the processing of the second operation, an operation of resetting all of the anomaly levels to a nonselected state and starting the next processing of the second operation is repeated. At this time, the next processing of the second operation may be started immediately after the finishing of the processing of the second operation, or may be started when a predetermined period of time has elapsed after the finishing of the processing of the second operation. Alternatively, the next processing of the second operation may be started every time a predetermined amount of monitoring data is newly stored in the storage unit 130A. At this time, targeting only on monitoring data at a specific monitoring level, the next processing of the second operation may be started every time a predetermined amount of monitoring data at the target monitoring level is newly stored in the storage unit 130A. Alternatively, the next processing of the second operation may be started every time the driving state of a vehicle changes. In addition, some starting conditions may be set by selecting from the above-described starting conditions, and the next processing of the second operation may be started when any one of the set starting conditions is satisfied.

### Advantageous Effects, Etc.

As described above, with the monitoring device 100A according to the present embodiment, it is possible to transmit, for each of the anomaly levels, monitoring data to the server, according to the amount of data. Accordingly, a frequency of transmitting monitoring data can be controlled, making it possible to reduce the amount of communication.

In addition, with the monitoring device 100A according to the present embodiment, it is possible to weight a data amount using a first weight value corresponding to an anomaly level. Accordingly, the frequency of transmitting monitoring data can be controlled according to the anomaly level, and thus it is possible to transmit monitoring data according to the degree of importance of monitoring.

In addition, with the monitoring device 100A according to the present embodiment, it is possible to use a second weight value corresponding to an estimated driving state for weighting an amount of data, in addition to the first weight value. Accordingly, the frequency of transmitting monitoring data can be controlled according to the driving state of the vehicle, and thus it is possible to transmit monitoring data according to the degree of importance of monitoring.

### Variation

Next, a variation of the above-described Embodiment 3 will be described.

Although both of the first weight value and the second weight value are used in weighting a data amount according to the above-described Embodiment 3, the present disclosure is not limited to this example. For example, only one of the first weight value and the second weight value may be used in weighting a data amount.

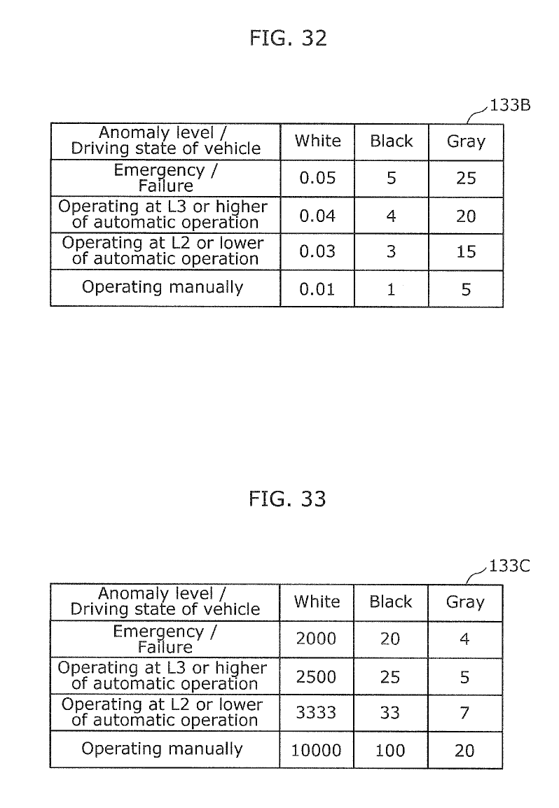

In addition, in the weighting data 133A according to the above-described Embodiment 3, the first weight value corresponding to the anomaly level and the second weight value corresponding to the driving state are separately managed. However, the first weight value and the second weight value may be integrally managed. In this case, for example, weighting data 133B illustrated in FIG. 32 may be stored in the storage unit 130A, instead of the weighting data 133A illustrated in FIG. 29A and FIG. 29B.

In addition, although the weighted data amount is compared with a common threshold according to the above-described Embodiment 3, the threshold may be weighted. In this case, threshold data 133C illustrated in FIG. 33 may be stored in the storage unit 130A, instead of the weighting data 133A illustrated in FIG. 29A and FIG. 29B.

In addition, although a method of storing the monitoring data 131A stored in the storage unit 130A of the monitoring device 100A is not specifically described in the above-described Embodiment 3, the method of storing may be changed according to an anomaly level. For example, the monitoring data 131A may first be stored in a volatile region of the storage unit 130A, and may be transferred to a non-volatile region of the storage unit 130A according to a storage period of time in the volatile region or a data amount. The monitoring data 131A stored in the non-volatile region in the storage unit 130A is transmitted for each of the anomaly levels by the communication control unit 332. However, the monitoring data 131A may stay in the non-volatile region as it is without being deleted, if a predetermined condition is satisfied. At this time, the monitoring data 131A may be subjected to data compression, or may be encrypted. For example, the monitoring data of gray or black indicating driving at level 3 of the automatic operation may be held in the non-volatile region for a specific period of time after the monitoring data is transmitted to the server 30. With this, it is possible to respond to a request from the server 30 for retransmission of the monitoring data, and also possible to implement forensics.

In addition, although the weighting data 133A is not particularly updated according to the above-described Embodiment 2, the weighting data 133A may be updated. For example, the monitoring device 100A may receive new weighting data from the server 30A, and update the weighting data 133A in the storage unit 130A by the received new weighting data.

### OTHER EMBODIMENTS

Although the control apparatus according to one or more aspects of the present disclosure has been described above based on the embodiments, the present disclosure is not limited to the above-described embodiments. Other forms in which various modifications apparent to those skilled in the art are applied to the embodiments, or forms structured by combining structural components of different embodiments may be included within the scope of one or more aspects of the present disclosure, unless such changes and modifications depart from the scope of the present disclosure.

For example, although the first determination unit determines, based on communication data passing through a network to which a plurality of electronic control units are connected in a system, an anomaly level of the communication data in Embodiments 2 and 3, and an operating state of the system in Embodiment 1, the first determination unit may determine both of the anomaly level and the operating state. In other words, the first determination unit may determine, based on communication data passing through a network to which a plurality of electronic control units are connected in a system, both of the anomaly level of the communication data and the operating state of the system. With this, the first control unit may change at least one of the method of transmitting a log of the communication data and the method of storing a log of the communication data, according to the determined anomaly level of the communication data, and may perform sampling on the communication data according to a method of sampling corresponding to the determined operating state. In this manner, it is possible to more effectively reduce the load of communication with an external device and a storage capacity of the device, by combining the embodiments.

For example, in the above-described embodiments, a method of transmitting according to a data amount described in Embodiment 3 may be applied to transmitting a log in Embodiment 2.

It should be noted that the format and content of data described in each of the above-described embodiments are presented as examples, and the present disclosure is not limited to these examples.

In addition, a part or all of the structural components of the control unit included in the control apparatus in each of the above-described embodiments may be configured from a single system LSI (Large-Scale Integration).

The system LSI is a super-multi-function LSI manufactured by integrating structural components on one chip, and is specifically a computer system configured by including a microprocessor, a read only memory (ROM), a random access memory (RAM), and so on. A computer program is stored on the ROM. The system LSI achieves its function through the microprocessor's operation according to the computer program.

Although a system LSI is mentioned here, the integrated circuit may be referred to as an IC, an LSI, a super LSI, or an ultra LSI depending on the scale of integration. Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or settings of circuit cells inside an LSI may be used for the same purpose.

In the future, with advancement in semiconductor technology, a brand-new technology may replace LSI. The functional blocks can be integrated using such a technology. There can be a possibility of adaptation of biotechnology, for example.

Furthermore, in addition to such a control apparatus, one aspect of the present disclosure may be a control method including, as steps, the characteristic components included in the control apparatus.

More specifically, as illustrated in FIG. 9, FIG. 11, and FIG. 15, the control method includes: determining, based on communication data passing through a network to which a plurality of electronic control unit are connected in a system, an anomaly level of the communication data or an operating state of the system (Step S102 and Step S905); and changing at least one of a method of transmitting a log of the communication data and a method of storing a log the communication data, according to a determined anomaly level of the communication data (Step S104 and Step S106), or performing sampling on the communication data according to a method of sampling according to the determined operating state (Step S1111).

In addition, one aspect of the present disclosure may be a computer program which causes a computer to execute each of the characteristic steps included in the control method. Furthermore, one aspect of the present disclosure may be a non-transitory computer-readable recording medium having such a computer program recorded thereon.

It should be noted that, each of the structural components in the above-described embodiments may be configured in the form of an exclusive hardware product, or may be realized by executing a software program suitable for the structural components. Each of the structural components may be realized by means of a program executing unit, such as a CPU and a processor, reading and executing the software program recorded on a recording medium such as a hard disk drive or a semiconductor memory. Here, the software program for realizing the control apparatus, etc. according to each of the embodiments described above is a program as described below.

The program causes a computer to execute a process of determining, based on communication data passing through a network to which a plurality of electronic control units are connected in a system, an anomaly level of the communication data or an operating state of the system, and a process of (i) changing at least one of a method of transmitting a log of the communication data and a method of storing a log of the communication data according to the determined anomaly level of the communication data or (ii) performing sampling on the communication data according to a method of sampling corresponding to the determined operating state.

### INDUSTRIAL APPLICABILITY

The present disclosure is applicable to an apparatus which transfers, to a server device, communication data passing through a network in an automobile, a construction machinery, an agricultural machinery, a vessel, a railroad, an airplane, etc.

1. A control apparatus, comprising:
a determiner, which, in operation, determines, based on communication data transmitting through a network in which a plurality of electronic control units is coupled in a system, an anomaly level of the communication data or an operating state of the system; and
a controller, which, in operation, (i) changes at least one of a method of transmitting a log of the communication data and a method of storing the log of the communication data, according to the determined anomaly level of the communication data, or (ii) performs sampling on the communication data according to a method of sampling corresponding to the determined operating state.

2. The control apparatus according to claim 1, comprising:
a first communicator, which, in operation, obtains the communication data on the network, wherein
the determiner, in operation, determines, based on a predetermined determination rule, the anomaly level of the communication data from among a plurality of anomaly levels including anomalous, normal, and indeterminable.

3. The control apparatus according to claim 2, wherein
the determiner, in operation, extracts a feature value from the communication data, and determines the anomaly level of the communication data using the extracted feature value.

4. The control apparatus according to claim 3, wherein
the first communicator, in operation, obtains a plurality of communication data including the communication data, and
the determiner, in operation, extracts, as a feature value included in the feature value, a value included in at least one communication data having a predetermined identifier, among the plurality of communication data.

5. The control apparatus according to claim 3, wherein
the first communicator, in operation, obtains a plurality of communication data including the communication data, and
the determiner, in operation, extracts, as a feature value included in the feature value, an amount of change in a value included in each of at least two communication data having a predetermined identifier, among the plurality of communication data.

6. The control apparatus according to claim 3, wherein
the first communicator, in operation, obtains a plurality of communication data including the communication data, and
the determiner, in operation, extracts, as a feature value included in the feature value, a time difference between transmission time points of at least two communication data each having a predetermined identifier, among the plurality of communication data.

7. The control apparatus according to claim 2, further comprising:
a second communicator, which, in operation, communicates with a server via another network different from the network, wherein
the controller, in operation, controls the second communicator so as to:
transmit the log of the communication data to the server when in response to the anomaly level of the communication data being determined as anomalous;
avoid transmitting the log of the communication data to the server in response to the anomaly level of the communication data being determined as being normal; and
in response to the anomaly level of the communication data being determined as indeterminable, (i) transmit a feature value of the communication data to the server, and (ii) transmit the log of the communication data to the server in response to a result of determination indicating that the anomaly level of the communication data is anomalous being received from the server.

8. The control apparatus according to claim 2, further comprising:
a first storage for storing the log of the communication data; and
a second storage for temporarily storing the log of the communication data, wherein
the controller, in operation, controls the first storage and the second storage so as to:
store the log of the communication data in the first storage in response to the anomaly level of the communication data item being determined as anomalous; and
in response to the anomaly level of the communication data being determined as indeterminable, (i) store the log of the communication data in the second storage, (ii-1) transfer, to the first storage, the log of the communication data stored in the second storage in response to a result of determination indicating that the anomaly level of the communication data is anomalous being received from the server, and (ii-2) delete the log of the communication data in response to a result of determination indicating that the anomaly level of the communication data is normal being received from the server.

9. The control apparatus according to claim 2, further comprising:
a second communicator, which, in operation, communicates with a server via other network different from the network; and
a first storage for storing the log of the communication data, wherein
the first communicator, in operation, obtains a plurality of communication data including the communication data,
the first storage, in operation, stores, as monitoring data, the plurality of communication data sorted by the anomaly level determined for each of the plurality of communication data, and
the controller, in operation, controls the second communicator so as to:
obtain a data amount of the monitoring data stored in the first storage, for each of the plurality of anomaly levels; and
transmit, to the server, the monitoring data according to the data amount, for each of the plurality of anomaly levels.

10. The control apparatus according to claim 9, wherein
the controller, in operation, controls the second communicator so as to:
weigh the data amount using a first weight value for each of the plurality of anomaly levels, the first weight value corresponding to the anomaly level; and
transmit, for each of the plurality of anomaly levels, the monitoring data to the server when the data amount weighted is greater than a predetermined threshold.

11. The control apparatus according to claim 10, wherein
the controller further includes a driving state estimator configured to estimate a driving state of the system, and
the controller, in operation, controls the second communicator so as to use a second weight value in addition to the first weight value in weighting the data amount, the second weight value corresponding to the estimated driving state.

12. The control apparatus according to claim 1, further comprising:
a transmitter and a storage, wherein
the transmitter, in operation, transmits the communication data on which the sampling is performed, to a device external to the system, and
the controller, in operation, stores, in the storage, the communication data on which the sampling is performed.

13. The control apparatus according to claim 1, wherein
in the method of sampling, a sampling rate is determined for each group including one or more electronic control units among the plurality of electronic control units, and
the controller, in operation, performs the sampling on the communication data in each group, according to the determined sampling rate for each group.

14. The control apparatus according to claim 13, wherein
in the network, the plurality of electronic control units is coupled to one another by CAN buses in the system, and
each group includes the one or more electronic control units coupled to a same CAN bus among the CAN buses.

15. The control apparatus according to claim 13, wherein
each group includes the one or more electronic control units each of which transmits a message related to a same function and included in the communication data.

16. The control apparatus according to claim 1, wherein
the determiner, in operation, further determines whether the network is in a normal state, and determines the operating state of the system based on a result of the determining of whether the network is in the normal state.

17. The control apparatus according to claim 16, wherein
the determiner, in operation, determines whether the network is in the normal state, by determining whether a message included in the communication data is normal.

18. The control apparatus according to claim 16, wherein
in the network, the plurality of electronic control units is coupled to one another by a CAN bus in the system, and
the determiner, in operation, determines whether the network is in the normal state, by determining whether the CAN bus in the network is normal.

19. A control method for a control apparatus, the control method comprising:
determining, based on communication data transmitting through a network in which a plurality of electronic control units is coupled in a system, an anomaly level of the communication data or an operating state of the system; and
(i) changing at least one of a method of transmitting a log of the communication data and a method of storing the log of the communication data, according to the anomaly level of the determined communication data, or (ii) performing sampling on the communication data according to a method of sampling corresponding to the determined operating state.

20. A non-transitory computer-readable recording medium having a set of computer readable instructions that, when executed, causes a control apparatus to:
determine, based on communication data transmitting through a network in which a plurality of electronic control units is coupled in a system, an anomaly level of the communication data item or an operating state of the system; and
(i) change at least one of a method of transmitting a log of the communication data a method of storing the log of the communication data, according to the anomaly level of the determined communication data, or (ii) perform sampling on the communication data according to a method of sampling corresponding to the determined operating state.
